(19) United States
(12) Patent Application Publication
(10) Pub. No.: US 2026/0084977 A1
(43) Pub. Date: Mar. 26, 2026

(54) COMPOSITIONS, METHODS, AND SYSTEMS RELATED TO CALCIUM CARBONATE BLENDS

(71) Applicant: Arelac, Inc., San Jose, CA (US)

(72) Inventors: Ryan J. Gilliam, San Jose, CA (US); Craig W. Hargis, Colorado Springs, CO (US)

(21) Appl. No.: 19/109,915

(22) PCT Filed: Sep. 6, 2023
(86) PCT No.: PCT/US2023/073538

§ 371 Date: Mar. 7, 2025

Related U.S. Application Data
(60) Provisional application No. 63/404,462, filed on Sep. 7, 2022.

(51) Int. Cl. C01F 11/18; C04B 14/28; C04B 28/10; C04B 103/44

(52) U.S. Cl. CPC C01F 11/185; C04B 14/28; C04B 28/10; C01P 2002/30; C01P 2004/45; C01P 2004/61; C01P 2004/62; C01P 2006/12; C04B 2103/44

(57) ABSTRACT

Provided herein are calcium carbonate blend compositions, methods, and systems related to blend comprising vaterite particles and GCC particles.

### CROSS-REFERENCE TO RELATED APPLICATION

This application claims the benefit of priority to U.S. Provisional Patent Application Ser. No. 63/404,462 entitled “COMPOSITIONS, METHODS, AND SYSTEMS RELATED TO CALCIUM CARBONATE BLENDS,” filed Sep. 7, 2022, the disclosure of which is incorporated herein in its entirety by reference.

### BACKGROUND

Carbon dioxide (CO₂) emissions have been identified as a major contributor to the phenomenon of global warming. CO₂ is a by-product of combustion, and it creates operational, economic, and environmental problems. It may be expected that elevated atmospheric concentrations of CO₂ and other greenhouse gases can facilitate greater storage of heat within the atmosphere leading to enhanced surface temperatures and rapid climate change. In addition, elevated levels of CO₂ in the atmosphere may also further acidify the world's oceans due to the dissolution of CO₂ and formation of carbonic acid. Reducing potential risks of climate change requires sequestration and avoidance of CO₂ from various anthropogenic processes. Concrete is the second most consumed product on earth behind water and cement production accounts for up to 8% of world's CO₂ emissions. Cement material needs to be properly selected to be environment friendly, durable, blended for optimum efficiency, and properly controlled to produce consistent concrete strength, workability, finish-ability, and durability.

### SUMMARY

Provided herein are calcium carbonate blend compositions, methods, and systems comprising blend comprising vaterite particles and ground calcium carbonate particles which alone or when mixed with other components result in cement, concrete, mortar, composite, and/or non-cementitious products that are environmentally friendly and high in workability, strength, and durability.

In one aspect, there is provided a calcium carbonate blend composition, comprising a blend comprising vaterite particles having an average particle size of between about 0.1-50 μm and ground calcium carbonate (GCC) particles having an average particle size of between about 1-150 μm.

In some embodiments of the foregoing aspect, the blend comprises vaterite particles having an average particle size of between about 10-25 μm and the GCC particles having an average particle size of between about 1-10 μm. In some embodiments of the foregoing aspect and embodiments, the blend comprises vaterite particles between about 3-97% by weight and the GCC particles between about 3-97% by weight. In some embodiments of the foregoing aspect and embodiments, the blend comprises vaterite particles between about 3-50% by weight and the GCC particles between about 3-50% by weight. In some embodiments of the foregoing aspect and embodiments, the blend improves packing density of cement paste by between about 1-35%; reduces viscosity of cement paste by about 10% or more; and/or increases strength of cement paste, mortar, concrete, or composite by about 5% or more. In some embodiments of the foregoing aspect and embodiments, the vaterite is stable vaterite, reactive vaterite, or combination thereof. In some embodiments of the foregoing aspect and embodiments, the blend comprises vaterite particles having a specific surface area of between about 200-40,000 m²/kg and the GCC particles having a specific surface area of between about 100-10,000 m²/kg. In some embodiments of the foregoing aspect and embodiments, the GCC particles are synthetic, natural, or combination thereof. In some embodiments of the foregoing aspect and embodiments, the vaterite particles further comprise magnesium oxide. In some embodiments of the foregoing aspect and embodiments, the composition further comprises other component comprising aluminosilicate material. In some embodiments of the foregoing aspect and embodiments, the aluminosilicate material comprises heat-treated clay, natural or artificial pozzolan, shale, granulated blast furnace slag, or combination thereof. In some embodiments of the foregoing aspect and embodiments, the heat-treated clay comprises calcined clay, aluminosilicate glass, calcium aluminosilicate glass, or combination thereof. In some embodiments of the foregoing aspect and embodiments, the pozzolan is selected from the group consisting of fly ash, volcanic ash, and mixture thereof. In some embodiments of the foregoing aspect and embodiments, the composition further comprises one or more other component selected from the group consisting of slag from metal production, Portland cement clinker, calcium aluminate cement clinker, calcium sulfoaluminate cement clinker, aluminosilicate material, supplementary cementitious material (SCM), and combination thereof. In some embodiments of the foregoing aspect and embodiments, the composition further comprises other component comprising carbonate material comprising magnesium carbonate, calcium magnesium carbonate, or combination thereof. In some embodiments of the foregoing aspect and embodiments, the composition further comprises other component comprising alkali metal accelerator or an alkaline earth metal accelerator. In some embodiments of the foregoing aspect and embodiments, the alkali metal accelerator or the alkaline earth metal accelerator is selected from sodium sulfate, sodium carbonate, sodium nitrate, sodium nitrite, sodium hydroxide, potassium sulfate, potassium carbonate, potassium nitrate, potassium nitrite, potassium hydroxide, lithium sulfate, lithium carbonate, lithium nitrate, lithium nitrite, lithium hydroxide, calcium sulfate, calcium nitrate, calcium nitrite, and combination thereof. In some embodiments of the foregoing aspect and embodiments, there is provided the composition comprising by weight between about 5-50% of the blend, between about 5-50% calcined clay, and between about 15-90% Portland cement clinker. In some embodiments of the foregoing aspect and embodiments, the composition after setting and hardening has a 28-day compressive strength of at least 21 MPa. In some embodiments of the foregoing aspect and embodiments, the composition further comprises other component comprising admixture selected from the group consisting of set accelerator, set retarder, air-entraining agent, foaming agent, defoamer, alkali-reactivity reducer, bonding admixture, dispersant, coloring admixture, corrosion inhibitor, damp-proofing admixture, gas former, permeability reducer, pumping aid, shrinkage compensation admixture, fungicidal admixture, germicidal admixture, insecticidal admixture, rheology modifying agent, finely divided mineral admixture, pozzolan, aggregate, wetting agent, strength enhancing agent, water repellent, reinforcing material, and combination thereof.

In one aspect, there is provided a concrete mix comprising the calcium carbonate blend composition of any one of the foregoing aspects and embodiments and aggregate.

In one aspect, there is provided calcium carbonate blend paste or calcium carbonate blend slurry composition, comprising: a blend comprising vaterite particles having an average particle size of between about 0.1-50 μm and GCC particles having an average particle size of between about 1-150 μm, and water, and optionally interlocking acicular shaped aragonite, calcite, carboaluminate, or combination thereof.

In one aspect, there is provided a cement product formed from the calcium carbonate blend composition of any one of the foregoing aspects and embodiments, comprising: an interlocking acicular shaped aragonite microstructure and the GCC particles. In some embodiments of the foregoing aspect and embodiments, the interlocking acicular shaped aragonite surrounds one or more voids optionally forming a honeycomb structure.

In one aspect, there is provided a cement product formed from the calcium carbonate blend composition of any one of the foregoing aspect and embodiments, comprising a calcite matrix and the GCC particles surrounding one or more voids optionally forming a honeycomb structure. In some embodiments of the foregoing aspect and embodiments, the cement product is building material, formed building material, and/or artificial marine structure.

In one aspect, there is provided a method of producing a calcium carbonate blend composition, comprising (a) calcining limestone to form a mixture comprising lime and a gaseous stream comprising carbon dioxide; (b) dissolving the mixture comprising lime in a N-containing salt solution to produce an aqueous solution comprising calcium salt; (c) treating the aqueous solution comprising calcium salt with the gaseous stream comprising carbon dioxide to form a composition comprising vaterite particles having an average particle size of between about 0.1-50 μm; (d) blending the composition comprising vaterite particles with GCC particles to form a blend comprising the vaterite particles having an average particle size of between about 0.1-50 μm and the GCC particles having an average particle size of between about 1-150 μm; and (e) forming a calcium carbonate blend composition comprising the blend.

In one aspect, there is provided a method of producing a calcium carbonate blend composition, comprising (a) dissolving limestone in a N-containing salt solution to produce an aqueous solution comprising calcium salt and a gaseous stream comprising carbon dioxide; (b) treating the aqueous solution comprising calcium salt with the gaseous stream comprising carbon dioxide to form a composition comprising vaterite particles having an average particle size of between about 0.1-50 μm; (c) blending the composition comprising the vaterite particles with GCC particles to form a blend comprising the vaterite particles having an average particle size of between about 0.1-50 μm and the GCC particles having an average particle size of between about 1-150 μm; and (d) forming a calcium carbonate blend composition comprising the blend.

In some embodiments of the foregoing aspect and embodiments, the vaterite is reactive vaterite, stable vaterite, or combination thereof. In some embodiments of the foregoing aspect and embodiments, the method further comprises forming cementitious product and/or non-cementitious product from the calcium carbonate blend composition. In some embodiments of the foregoing aspect and embodiments, the method further comprising adding water to the calcium carbonate blend composition and transforming the reactive vaterite particles to aragonite and/or calcite upon dissolution and re-precipitation in water. In some embodiments of the foregoing aspect and embodiments, the method further comprising setting and hardening of the aragonite and/or the calcite and forming cementitious product. In some embodiments of the foregoing aspect and embodiments, the blend improves packing density of cement paste by between about 1-35%; reduces viscosity of cement paste by 10% or more; and/or increases strength of cement paste, mortar, concrete, or composite by 5% or more.

In one aspect, there is provided a system to form a calcium carbonate blend composition, comprising:
(i) a calcining reactor configured to calcine limestone to form a mixture comprising lime and a gaseous stream comprising carbon dioxide;
(ii) a dissolution reactor operably connected to the calcination reactor configured for dissolving the mixture comprising lime in an aqueous N-containing salt solution to produce an aqueous solution comprising calcium salt;
(iii) a treatment reactor operably connected to the dissolution reactor configured for treating the aqueous solution comprising calcium salt with the gaseous stream comprising carbon dioxide to form a composition comprising vaterite particles having an average particle size of between about 0.1-50 μm; and
(iv) a blending station operably connected to the treatment reactor and configured for forming a blend comprising the vaterite particles having an average particle size of between about 0.1-50 μm and GCC particles having an average particle size of between about 1-150 μm and forming a calcium carbonate blend composition comprising the blend.

In one aspect, there is provided a system to form a calcium carbonate blend composition, comprising:
(i) a dissolution reactor configured for dissolving limestone with N-containing salt solution to produce an aqueous solution comprising calcium salt and a gaseous stream comprising carbon dioxide;
(ii) a treatment reactor operably connected to the dissolution reactor configured for treating the aqueous solution comprising calcium salt with the gaseous stream comprising carbon dioxide to form a composition comprising vaterite particles having an average particle size of between about 0.1-50 μm; and
(iii) a blending station operably connected to the treatment reactor and configured for forming a blend comprising the vaterite particles having an average particle size of between about 0.1-50 μm and GCC particles having an average particle size of between about 1-150 μm and forming a calcium carbonate blend composition comprising the blend.

### DRAWINGS

The features of the invention are set forth with particularity in the appended claims. A better understanding of the features and advantages of the invention will be obtained by reference to the following detailed description that sets forth illustrative embodiments, in which the principles of the invention are utilized, and the accompanying drawings of which:

FIG. 1 illustrates some embodiments of the calcium carbonate blend compositions (illustrated as CCBC) comprising the vaterite particles and the GCC particles.

FIG. 2A illustrates some embodiments of the methods and systems provided herein employing the calcination of the limestone to form the calcium carbonate blend compositions (illustrated as CCBC).

FIG. 2B illustrates some embodiments of the methods and systems provided herein employing the limestone directly to form the calcium carbonate blend compositions (illustrated as CCBC).

FIG. 3A illustrates some embodiments of the methods and systems provided herein employing the calcination of the limestone to form the calcium carbonate blend compositions (illustrated as CCBC).

FIG. 3B illustrates some embodiments of the methods and systems provided herein employing the limestone directly to form the calcium carbonate blend compositions (illustrated as CCBC).

FIG. 4A illustrates some embodiments of the methods and systems provided herein employing the calcination of the limestone to form the calcium carbonate blend compositions (illustrated as CCBC).

FIG. 4B illustrates some embodiments of the methods and systems provided herein employing the limestone directly to form the calcium carbonate blend compositions (illustrated as CCBC).

FIG. 5 illustrates SEM images (×1000 magnification and ×2500 magnification) of the product, formed from the calcium carbonate blend composition comprising calcite matrix as described in Example 1 herein.

### DESCRIPTION

Disclosed herein are unique compositions, methods, and systems related to the calcium carbonate blend compositions comprising the blend of the vaterite particles and the GCC particles which alone or when mixed with other components result in cement or cement product(s), concrete, mortar, composite, and/or non-cementitious product(s) that are environmentally friendly and high in workability, strength, and durability.

### I. Compositions

Provided herein are the calcium carbonate blend compositions, comprising the blend comprising the vaterite particles and the ground calcium carbonate (GCC) particles. In some embodiments, there are provided the calcium carbonate blend compositions, comprising the blend comprising the vaterite particles having an average particle size of between about 0.1-50 μm and the GCC particles having an average particle size of between about 1-150 μm. Methods and systems to form the compositions comprising the vaterite particles have been provided herein. The vaterite particles can be the reactive vaterite particles or the stable vaterite particles.

The “reactive vaterite” or the “reactive vaterite particles” as used interchangeably herein, includes vaterite material that transforms to the interlocking acicular shaped aragonite and/or calcite and/or carboaluminates during and/or after dissolution-re-precipitation process in water and sets and hardens into the cement or the cement product (along with the GCC particles). In some embodiments, the reactive vaterite particles provided herein have spherical morphology. The carboaluminate or the carboaluminate hydrate includes, but not limited to, monocarboaluminate, hemicarboaluminate, or combination thereof.

The “stable vaterite” or the “stable vaterite particles” as used interchangeably herein, includes vaterite that does not transform to the aragonite or the calcite during and/or after dissolution-reprecipitation process. In some embodiments, the stable vaterite either stays in the vaterite form or transforms over a long period of time to the calcite.

In some embodiments, the blend comprising the vaterite (reactive or stable) and the GCC particles may be used as a filler or alternative supplementary cementitious material (SCM) when mixed with the other components such as, e.g., Portland Cement (PC) or Portland cement clinker. The blend comprising the vaterite and the GCC particles may also be used to form the non-cement products, for example only, additive or filler in sealants, adhesives, plastics, rubber, inks, paper, pharmaceuticals, nutritional supplements, coating, paint, and the like. Various examples of the non-cement products have been provided herein.

The “composition comprising vaterite particles” as used herein includes the composition that comprises stable vaterite and/or the reactive vaterite particles and optionally the aragonite, the calcite, or the combination thereof. The methods and systems to form the composition comprising the vaterite particles have been provided herein.

As used herein, the “supplementary cementitious material” (SCM) includes SCM as is well known in the art. In some embodiments, the SCM is mixed with cement and add properties to the hardened concrete. In some embodiments, the SCM provides or enhances hydraulic and/or pozzolanic activity in the cement. In some embodiments, the SCM comprises slag, fly ash, volcanic ash, silica fume, calcined clay, calcined shale, natural pozzolans, ground glass, incineration ashes, or combinations thereof. Various other examples of the SCM are known in the art and are well within the scope of the invention.

The “other components” as used herein, includes one or more components that may be added to the blend provided herein to form the calcium carbonate blend composition. Various examples of the other components have been provided herein and include, without limitation, slag from metal production, Portland cement clinker, calcium aluminate clinker, calcium sulfoaluminate cement clinker, aluminosilicate material, SCM, carbonate material, alkali metal accelerator, alkaline earth metal accelerator, plasticizer, admixture, additive, or combination thereof.

The “ground calcium carbonate” or the “GCC” or the “GCC particles” as used interchangeably herein, includes any form of ground or non-ground calcium carbonate that may be added to the composition comprising the vaterite to form the blend, as provided herein. In some embodiments, the GCC includes, e.g., limestone (of any composition), calcite form of calcium carbonate, a natural form of calcium carbonate (e.g., chalk, limestone, marble, skeletal remains of sea creatures and organisms, etc.), a synthetic form of calcium carbonate (e.g., PCC), precipitated calcium carbonate (PCC), raw or treated (such as, e.g., through carbonation and/or separation) cement kiln dust (CKD), raw or treated (such as, e.g., through carbonation and/or separation) lime kiln dust (LKD), or combination thereof. In some embodiments, the GCC may comprise several impurities including, but not limited to, small amounts of quartz and/or sand. In some embodiments, the GCC may be pure GCC.

The “precipitated calcium carbonate” or “PCC” as used herein includes conventional PCC with high purity and micron or lesser sized particles. The PCC can be in any polymorphic form of calcium carbonate including but not limited to vaterite, aragonite, calcite, or combination thereof. In some embodiments, the PCC has a particle size in nanometers or between 0.001 micron to 5 microns.

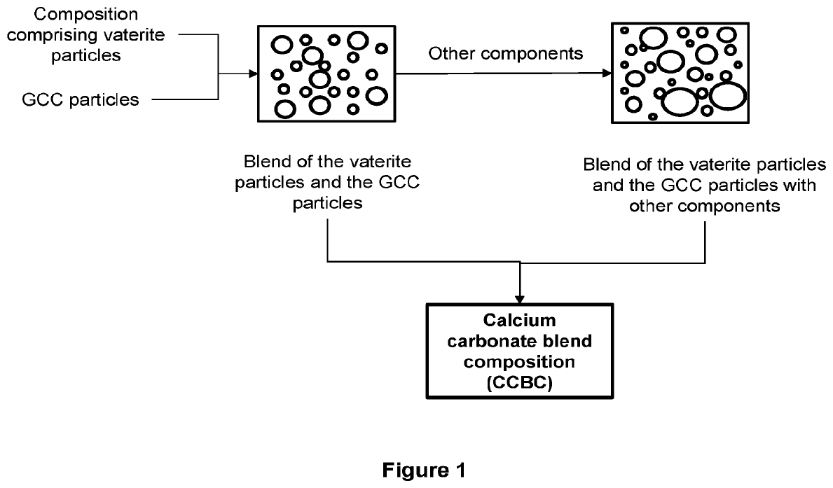

As illustrated in FIG. 1, the composition comprising the vaterite particles is blended with the GCC particles to form the blend comprising the vaterite particles and the GCC particles. The blend may optionally be mixed with the other components (described herein) to form the calcium carbonate blend composition (CCBC). The CCBC can be used to form the cement product and/or the non-cement product. It is to be understood that FIG. 1 is merely a pictorial representation of the particle blend and is in no way limiting to the particle size, particle distribution, blend design or packing density or flow or any other property of the blend. In some embodiments, the vaterite particles are the reactive vaterite particles that undergo transformation in water to form the aragonite and/or the calcite that sets and hardens into the cement; or in some embodiments the vaterite particles are stable vaterite particles that do not transform and act as the filler in non-cement product and/or acts as the alternative SCM in cement compositions. Therefore, the blend of the vaterite particles and the GCC particles provided herein can itself act as the cement (self-cement); may aid the cementation of the cement compositions when mixed with the other components (e.g., Portland cement clinker, calcium aluminate cement clinker, or calcium sulfoaluminate cement clinker, etc.); may act as the filler in the non-cement compositions; and/or may act as the alternative SCM in the cement compositions. All these embodiments of the compositions, methods and systems are well within the scope of the invention.

Applicants surprisingly and unexpectedly found that blending the vaterite particles with the GCC particles may eliminate or reduce the need for further grinding of the GCC before mixing it with the other cement compositions such as Portland cement clinker, calcium aluminate cement clinker, or calcium sulfoaluminate cement clinker, etc. For example, it was found that in some embodiments, mixing a smaller sized vaterite (e.g., having an average particle size of between about 0.1-50 μm) with a larger sized GCC (e.g., having an average particle size of between about 1-150 μm) may eliminate the need for further grinding of the GCC before mixing in the cement compositions resulting in significant savings in cost and energy.

Applicants surprisingly and unexpectedly found that the blends provided herein may also result in high reactivity of the cement to set and harden as well as high flow and workability of the cement paste, concrete, mortar, and/or composite. Applicants also surprisingly found that the particle distribution and the particle size of the vaterite particles and the GCC particles in the blend composition affect the packing density or the bulk density of the cement product such that the cement products with ranges of the packing density or the bulk densities can be formed by using the desired particle distribution and the particle size of the vaterite particles and the GCC particles in the blend composition.

Applicants unexpectedly and surprisingly also found that the blend comprising the vaterite particles and the GCC particles of certain particles sizes (as provided herein) can be chosen to increase the reactivity of the cement paste or the cement slurry while also providing high flow or workability. For example only, the reactive vaterite particles, e.g., having an average particle size of between about 0.1-50 μm may result in high reactivity of the blend due to high surface area, resulting in rapid setting and hardening of the cement, high viscosity, or low flow; while the GCC particles, e.g., having an average particle size of between about 1-150 μm, may result in low reactivity due to low surface area, resulting in low viscosity or high flow. Therefore, the blend comprising the vaterite particles and the GCC particles of certain particles sizes can be chosen to control the reactivity, flow, and/or workability of the cement paste, the concrete, the mortar, and/or the composite. The blend may also interact with the other components added to the paste affecting its reactivity and flow. Therefore, in some embodiments, the calcium carbonate blend composition comprising the blend comprising the vaterite particles having an average particle size of between about 0.1-50 μm and the GCC particles having an average particle size of between about 1-150 μm, shows surprising and unexpected properties and can be used to make variety of cement and non-cement products.

Applicants also unexpectedly and surprisingly found that the water demand of the vaterite particles and the GCC particles of different sizes differs affecting the packing density or the bulk density of the cement product. For example, in some embodiments, the small sized vaterite particles may blend in with the large sized GCC particles, where the small vaterite particles may pack between the large GCC particles thereby increasing the solid volume and density hence increasing the packing density or the bulk density of the cement product. Furthermore, increased surface area in the vaterite particles may require more water to wet. More water in the paste may result in lower density cement product as the water after evaporation and drying may leave porosity or voids. Depending on the particle size of the vaterite particles in the blend, the volume of the space or the void can be modified to result in the space or the voids in the resulting cement product with varying packing density or bulk density.

Therefore, the particle size and the distribution in the blend comprising the vaterite particles and the GCC particles play an important role in the economics, the workability, the flow, the packing density and/or compressive strength of the cement product. Provided herein are the composition, methods and systems related to the blend comprising the vaterite particles and the GCC particles.

In one aspect, there is provided the calcium carbonate blend composition, comprising the blend comprising the vaterite particles having the average particle size of between about 0.1-50 μm and the GCC particles having the average particle size of between about 1-150 μm. The average particle size (or average particle diameter) may be determined using any conventional particle size determination method, such as, but not limited to, multi-detector laser scattering or laser diffraction or sieving.

In some embodiments, there is provided the calcium carbonate blend composition, comprising the blend comprising the vaterite particles having the average particle size of between about 0.1-50 μm; or between about 0.1-40 μm; or between about 0.1-30 μm; or between about 0.1-20 μm; or between about 0.1-10 μm; or between about 1-50 μm; or between about 1-40 μm; or between about 1-30 μm; or between about 1-20 μm; or between about 1-10 μm; or between about 5-50 μm; or between about 5-40 μm; or between about 5-30 μm; or between about 5-20 μm; or between about 5-10 μm; or between about 10-50 μm; or between about 10-40 μm; or between about 10-30 μm; or between about 10-20 μm; or between about 20-50 μm; or between about 20-40 μm; or between about 20-30 μm; or between about 30-50 μm; or between about 30-40 μm; or between about 40-50 μm; and the GCC particles having the average particle size of between about 1-150 μm.

In some embodiments, there is provided the calcium carbonate blend composition, comprising the blend comprising the vaterite particles having the average particle size of between about 0.1-50 μm; and the GCC particles having the average particle size of between about 1-150 μm; or between about 1-125 μm; or between about 1-100 μm; or between about 1-75 μm; or between about 1-50 μm; or between about 1-25 μm; or between about 1-20 μm; or between about 1-10 μm; or between about 1-5 μm; or between about 10-150 μm; or between about 10-125 μm; or between about 10-100 μm; or between about 10-75 μm; or between about 10-50 μm; or between about 10-25 μm; or between about 10-20 μm; or between about 25-150 μm; or between about 25-125 μm; or between about 25-100 μm; or between about 25-75 μm; or between about 25-50 am; or between about 50-150 μm; or between about 50-125 μm; or between about 50-100 μm; or between about 50-75 μm; or between about 75-150 μm; or between about 75-125 μm; or between about 75-100 μm.

In some embodiments, there is provided the calcium carbonate blend composition, comprising the blend comprising the vaterite particles having the average particle size of between about 0.1-50 μm; or between about 0.1-40 am; or between about 0.1-30 μm; or between about 0.1-20 μm; or between about 0.1-10 μm; or between about 1-50 μm; or between about 1-40 μm; or between about 1-30 μm; or between about 1-20 μm; or between about 1-10 μm; or between about 5-50 μm; or between about 5-40 μm; or between about 5-30 μm; or between about 5-20 μm; or between about 5-10 μm; or between about 10-50 am; or between about 10-40 μm; or between about 10-30 μm; or between about 10-20 μm; or between about 20-50 μm; or between about 20-40 μm; or between about 20-30 μm; or between about 30-50 μm; or between about 30-40 μm; or between about 40-50 μm; and
the GCC particles having the average particle size of between about 1-150 μm; or between about 1-125 μm; or between about 1-100 μm; or between about 1-75 μm; or between about 1-50 μm; or between about 1-25 μm; or between about 1-20 μm; or between about 1-10 μm; or between about 1-5 μm; or between about 10-150 μm; or between about 10-125 μm; or between about 10-100 μm; or between about 10-75 μm; or between about 10-50 μm; or between about 10-25 μm; or between about 10-20 μm; or between about 25-150 μm; or between about 25-125 μm; or between about 25-100 μm; or between about 25-75 μm; or between about 25-50 μm; or between about 50-150 μm; or between about 50-125 μm; or between about 50-100 μm; or between about 50-75 μm; or between about 75-150 μm; or between about 75-125 μm; or between about 75-100 μm.

In some embodiments, there is provided the calcium carbonate blend composition, comprising the blend comprising the vaterite particles having the average particle size of between about 10-50 μm; or between about 10-40 am; or between about 10-30 μm; or between about 10-20 μm; or between about 20-50 μm; or between about 20-40 μm; or between about 20-30 μm; or between about 30-50 μm; or between about 30-40 μm; or between about 40-50 μm; and the GCC particles having the average particle size of between about 1-20 μm; or between about 1-15 μm; or between about 1-10 μm; or between about 1-5 μm; or between about 1-2 μm; or between about 2-20 μm; or between about 2-15 μm; or between about 2-10 μm; or between about 2-5 μm; between about 5-20 μm; or between about 5-15 μm; or between about 5-10 μm.

In some embodiments, there is provided the calcium carbonate blend composition, comprising the blend comprising the vaterite particles having the average particle size of between about 10-25 μm; or between about 10-20 am; or between about 10-15 μm; and the GCC particles having the average particle size of between about 1-10 μm; or between about 1-5 μm; or between about 1-2 μm.

In some embodiments, there is provided the calcium carbonate blend composition, comprising the blend comprising the vaterite particles having the average particle size of between about 10-25 μm; and the GCC particles having the average particle size of between about 1-10 μm.

In some embodiments, there is provided the calcium carbonate blend composition, comprising the blend comprising the vaterite particles having the average particle size of between about 15-25 μm; and the GCC particles having the average particle size of between about 1-5 μm.

The vaterite provided in all the compositions provided herein (including the ones provided above), can be the stable vaterite or the reactive vaterite.

In some embodiments, the composition comprising the vaterite particles includes two or more, or three or more, or multi-modal, such as, e.g., or four or more, or five or more, or ten or more, or 20 or more, or 3-20, or 4-10 different sizes of the vaterite particles in the composition. For example, the composition may include two or more, or three or more, or between 3-20 particles ranging from 0.1-50 μm sizes of the vaterite particles.

In some embodiments, the GCC vaterite particles includes two or more, or three or more, or multi-modal, such as, e.g., or four or more, or five or more, or ten or more, or 20 or more, or 3-20, or 4-10 different sizes of the GCC particles in the composition. For example, the composition may include two or more, or three or more, or between 3-20 particles ranging from 1-150 μm sizes of the GCC particles.

In some embodiments, the blend comprising the vaterite particles and the GCC particles includes two or more, or three or more, or multi-modal, such as, e.g., or four or more, or five or more, or ten or more, or 20 or more, or 3-20, or 4-10 different sizes of the vaterite and the GCC particles in the blend composition. For example, the blend composition may include two or more, or three or more, or between 3-20 particles ranging from about 0.1-50 μm sizes of the vaterite particles and between about 1-150 μm of the GCC particles.

Bimodal, trimodal, or multi-modal distributions may allow the surface area to be minimized (due to larger size particles mixed in with the smaller sized particles of the aforementioned ranges), thus allowing a lower liquids/solids mass ratio (water to cement ratio) when the blend or the composition is mixed with the water allowing for higher flow rate. For example, the smaller sized particles with high surface area provide the reactive vaterite particles for early reaction to set and harden into the interlocking acicular aragonite form and/or the calcite form and/or the carboaluminate (formed with alumina in other components of the cement, such as, e.g., Portland cement).

In some embodiments of the aforementioned aspects, the blend comprises vaterite particles between about 3-97% by weight and the GCC particles between about 3-97% by weight. In some embodiments of the aforementioned aspects, the blend comprises vaterite particles between about 3-50% by weight and the GCC particles between about 3-50% by weight. In one aspect, there is provided the calcium carbonate blend composition, comprising the blend comprising between about 3-97% by weight vaterite particles having the average particle size of between about 0.1-50 μm and between about 3-97% by weight GCC particles having the average particle size of between about 1-150 μm.

In one aspect, there is provided the calcium carbonate blend composition, comprising the blend comprising between about 3-50% by weight vaterite particles having the average particle size of between about 0.1-50 μm and between about 3-50% by weight GCC particles having the average particle size of between about 1-150 μm.

In some embodiments, the blend comprises the vaterite particles between about 3-97% by weight; or between about 3-95% by weight; or between about 3-85% by weight; or between about 3-75% by weight; or between about 3-65% by weight; or between about 3-50% by weight; or between about 3-55% by weight; or between about 3-45% by weight; or between about 3-35% by weight; or between about 3-25% by weight; or between about 3-15% by weight; or between about 10-97% by weight; or between about 10-90% by weight; or between about 10-75% by weight; or between about 10-50% by weight; or between about 10-25% by weight; or between about 25-97% by weight; or between about 25-90% by weight; or between about 25-75% by weight; or between about 25-50% by weight; or between about 50-97% by weight; or between about 75-90% by weight; and the remaining amount of the GCC particles.

In some embodiments, the blend comprises the GCC particles between about 3-97% by weight; or between about 3-95% by weight; or between about 3-85% by weight; or between about 3-75% by weight; or between about 3-65% by weight; or between about 3-50% by weight; or between about 3-55% by weight; or between about 3-45% by weight; or between about 3-35% by weight; or between about 3-25% by weight; or between about 3-15% by weight; or between about 10-97% by weight; or between about 10-90% by weight; or between about 10-75% by weight; or between about 10-50% by weight; or between about 10-25% by weight; or between about 25-97% by weight; or between about 25-90% by weight; or between about 25-75% by weight; or between about 25-50% by weight; or between about 50-97% by weight; or between about 75-90% by weight; and the remaining amount of the composition comprising the vaterite particles.

In some embodiments, the blend comprises the GCC particles between about 3-50% by weight and the vaterite particles between about 3-50% by weight.

In some embodiments of the aforementioned aspects and embodiments, the blend comprising the vaterite particles and the GCC particles improves packing density of the cement paste (in water) by between about 1-35%, or between about 1-30%, or between about 1-25%, or between about 1-20%, or between about 1-15%, or between about 1-10%, or between about 1-5%, or between about 5-35%, or between about 5-30%, or between about 5-25%, or between about 5-20%, or between about 5-15%, or between about 5-10%, or between about 10-35%, or between about 10-25%, or between about 10-15%, or between about 20-35%, or between about 25-35%.

In some embodiments of the aforementioned aspects and embodiments, the blend comprising the vaterite particles and the GCC particles reduces viscosity (or increase flow or increase slump) of the cement paste (in water) by about 10% or more, or by about 20% or more, or about 30% or more.

In some embodiments of the aforementioned aspects and embodiments, the blend comprising the vaterite particles and the GCC particles increases strength of the cement paste, the mortar, the concrete, or the composite by about 5% or more, or by about 10% or more, or by about 20% or more, or about 30% or more.

In some embodiments, there is provided the calcium carbonate blend composition, comprising the blend comprising the vaterite particles having the average particle size of between about 0.1-50 μm and the GCC particles having the average particle size of between about 1-150 μm, wherein the blend improves packing density of cement paste by between about 1-35%; reduces viscosity of cement paste by about 10% or more; and/or increases strength of cement paste, mortar, concrete, or composite by about 5% or more.

As described herein, the size of the particles affects the surface area of the particles which in turn affects the water to cement ratio as well as the reactivity of the cement and the flow of the cement paste. In some embodiments, there is provided the calcium carbonate blend composition comprising the blend comprising the vaterite particles and the GCC particles, wherein the blend comprises vaterite particles having a specific surface area of between about 200-40,000 m²/kg and the GCC particles having a specific surface area of between about 100-10,000 m²/kg.

In some embodiments, the vaterite particles in the blend or in the CCBC, have the specific surface area of between about 200-40,000 m²/kg; or between about 200-20,000 m²/kg; or between about 200-10,000 m²/kg; or between about 200-800 m²/kg; or between about 200-600 m²/kg; or between about 500-40,000 m²/kg; or between about 500-20,000 m²/kg; or between about 500-15,000 m²/kg; or between about 500-800 m²/kg; or between about 500-600 m²/kg.

In some embodiments, the GCC particles in the blend or in the CCBC, have the specific surface area of between about 100-10,000 m²/kg; or between about 100-5,000 m²/kg; or between about 100-1,000 m²/kg; or between about 500-10,000 m²/kg; or between about 500-5,000 m²/kg; or between about 500-1,000 m²/kg; or between about 1,000-10,000 m²/kg; or between about 1,000-5,000 m²/kg.

In some embodiments of the compositions provided herein, the vaterite particles in the blend or in the CCBC, have the specific surface area of between about 500-15,000 m²/kg; and the GCC particles in the blend or in the CCBC, have the specific surface area of between about 100-10,000 m²/kg.

In some embodiments, there is provided the calcium carbonate blend composition comprising the blend comprising the vaterite particles having the average particle size of between about 0.1-50 μm and the GCC particles having the average particle size of between about 1-150 μm, wherein the blend comprises vaterite particles having a specific surface area of between about 200-40,000 m²/kg and the GCC particles having a specific surface area of between about 100-10,000 m²/kg.

The composition comprising vaterite, as provided herein, may optionally further comprise magnesium oxide. The magnesium oxide may be introduced into the vaterite particles during its production (described further herein) or may be added to the vaterite particles after its production. The magnesium oxide in the compositions comprising vaterite has been described in detail, in U.S. application Ser. No. 17/723,718, filed Apr. 19, 2022, which is incorporated herein by reference in its entirety.

The CCBC compositions provided herein comprising the blend comprising the vaterite particles and the GCC particles may optionally further comprise one or more other components selected from the group consisting of slag from metal production, Portland cement clinker, calcium aluminate clinker, calcium sulfoaluminate cement clinker, aluminosilicate material, supplementary cementitious material (SCM), or combination thereof. The aluminosilicate material includes any material that is rich in aluminate and silicate minerals. These materials can be natural or man-made. In some embodiments, the aluminosilicate material comprises heat-treated clay, e.g., calcined clay, natural or artificial pozzolan, shale, granulated blast furnace slag, or combination thereof. In some embodiments, the natural or artificial pozzolan is selected from the group consisting of fly ash, volcanic ash, or mixture thereof. Pozzolan may be naturally available and consist of very fine particles of siliceous and aluminous materials that in presence of water may react with Ca ions in the vaterite to form the cementitious materials. In some embodiments, the heat-treated clay includes, but not limited to, calcined clay, aluminosilicate glass, calcium aluminosilicate glass, or combination thereof.

Various other components that can be blended in the compositions provided herein, include but not limited to, carbonate material, such as limestone or calcium carbonate or magnesium carbonate or calcium magnesium carbonate; alkali metal accelerator; or alkaline earth metal accelerator etc. The alkali metal or the alkaline earth metal accelerator includes, but not limited to any alkali metal or an alkaline earth metal salt, such as e.g., sodium sulfate, sodium carbonate, sodium nitrate, sodium nitrite, sodium hydroxide, potassium sulfate, potassium carbonate, potassium nitrate, potassium nitrite, potassium hydroxide, lithium sulfate, lithium carbonate, lithium nitrate, lithium nitrite, lithium hydroxide, calcium sulfate (or gypsum), calcium nitrate, calcium nitrite, and combination thereof.

In some embodiments, the compositions comprising the vaterite particles may further comprise a magnesium and/or strontium cation. In some embodiments, the magnesium and/or strontium cation may facilitate the transformation of the reactive vaterite into the interlocking acicular shaped aragonite (described further herein). In some embodiments, the magnesium and/or strontium cation may be present in the form of a salt including, but not limited to, magnesium and/or strontium halide, or magnesium and/or strontium sulfate, or magnesium and/or strontium nitrate etc. In some embodiments, the magnesium and/or strontium salt is selected from the group consisting of magnesium carbonate, magnesium halide (fluoride, chloride, iodide, or bromide), magnesium hydroxide, magnesium silicate, magnesium sulfate, magnesium nitrate, magnesium nitrite, strontium carbonate, strontium halide, strontium hydroxide, strontium silicate, strontium sulfate, strontium nitrate, strontium nitrite, and combination thereof.

In some embodiments, the magnesium and/or strontium is present in range of between about 0.05-0.1 M. In some embodiments of the aforementioned methods and systems aspects and embodiments, amount of the magnesium salt and or the strontium salt used is between about 0-1M; or between about 0-0.5M; or between about 0.01-1M; or between about 0.01-0.5M; or between about 0.05-1M; or between about 0.05-0.5M; or between about 0.05-0.1M; or between about 0.1-1M; or between about 0.1-0.5M. In some embodiments of the aforementioned methods and systems aspects and embodiments, ratio of the magnesium salt to the strontium salt is between about 2:1 or about 1.5:1 or between about 1:1 or about 1:1.5 or between about 1:2.

In some embodiments of the foregoing aspects and embodiments, the compositions comprising the vaterite particles may further comprise less than 30% by weight aragonite and/or the calcite; or less than 25% by weight aragonite and/or the calcite; or less than 20% by weight aragonite and/or the calcite; or less than 10% by weight aragonite and/or the calcite; or less than 5% by weight aragonite and/or the calcite; or less than 1% by weight aragonite and/or the calcite; or between 1-10% by weight aragonite and/or the calcite; or between 1-30% by weight aragonite and/or the calcite. In some embodiments of the foregoing aspects and embodiments, the compositions comprising the vaterite particles comprise more than about 80% by weight vaterite; or between 80-100% by weight vaterite; or between about 85-100% by weight vaterite; or between about 90-100% by weight vaterite; or between about 95-100% by weight vaterite; or between about 99-100% by weight vaterite; or about 95% or about 99% or about 99.9% by weight vaterite; with the remaining amount being the aragonite and/or the calcite.

In some embodiments of the foregoing aspects and embodiments, the CCBC comprising the blend comprising the vaterite particles and the GCC particles (e.g., in the particle sizes described herein) provided herein may further comprise aluminosilicate material, e.g. calcined clay; and optionally limestone and/or alkali metal or alkaline earth metal accelerator, and further comprises between 5-90% by weight of the Portland cement clinker; or between 5-80% by weight; or between 5-70% by weight; or between 5-60% by weight; or between 5-50% by weight; or between 5-40% by weight; or between 5-30% by weight; or between 5-20% by weight; or between 5-10% by weight; or between 10-90% by weight; or between 10-80% by weight; or between 10-70% by weight; or between 10-60% by weight; or between 10-50% by weight; or between 10-40% by weight; or between 10-30% by weight; or between 10-20% by weight; or between 20-90% by weight; or between 20-80% by weight; or between 20-70% by weight; or between 20-60% by weight; or between 20-50% by weight; or between 20-40% by weight; or between 20-30% by weight; or between 30-90% by weight; or between 30-80% by weight; or between 30-70% by weight; or between 30-60% by weight; or between 30-50% by weight; or between 30-40% by weight; or between 40-90% by weight; or between 40-80% by weight; or between 40-70% by weight; or between 40-60% by weight; or between 40-50% by weight; or between 50-90% by weight; or between 50-80% by weight; or between 50-70% by weight; or between 50-60% by weight; or between 60-90% by weight; or between 60-80% by weight; or between 60-70% by weight; or between 70-90% by weight; or between 70-80% by weight; or between 80-90% by weight of the Portland cement clinker.

In some embodiments of the compositions provided herein, the composition comprises between about 0.1-5% by weight alkali metal or alkaline earth metal accelerator, e.g., lithium carbonate; or between about 0.1-4% by weight; or between about 0.1-3% by weight; or between about 0.1-2% by weight; or between about 0.1-1% by weight; or between about 0.1-0.5% by weight; or between about 1-5% by weight; or between about 1-4% by weight; or between about 1-3% by weight; or between about 1-2% by weight; or between about 2-5% by weight; or between about 2-4% by weight; or between about 2-3% by weight; or between about 3-5% by weight; or between about 3-4% by weight; or between about 4-5% by weight.

In some embodiments of the foregoing aspects and embodiments, the CCBC may include a blend of by weight about 75% PC (such as e.g., OPC) or Portland cement clinker and between about 1-25% of the blend comprising the vaterite particles and the GCC particles; or about 80% PC or Portland cement clinker and between about 1-20% of the blend comprising the vaterite particles and the GCC particles; or about 85% PC or Portland cement clinker and between about 1-15% of the blend comprising the vaterite particles and the GCC particles; or about 90% PC or Portland cement clinker and between about 1-10% of the blend comprising the vaterite particles and the GCC particles; or about 95% PC or Portland cement clinker and between about 1-5% of the blend comprising the vaterite particles and the GCC particles. The amounts and/or the particle sizes and/or the surface area of the distribution of the particles in the blend have all been described herein and all of them apply to various blends described herein. In some embodiments of the foregoing aspects and embodiments, the remaining amount in the composition may include one or more of the aluminosilicate materials, and optionally the carbonate material and the alkali metal or alkaline earth metal accelerator.

In some embodiments of the CCBC provided herein, the compositions comprise by weight between about 5-50% (particle sizes, amounts, ratios, and/or surface areas are described herein) of the blend comprising the vaterite particles and the GCC particles, between about 5-50% aluminosilicate material, e.g., heat-treated clay or calcined clay, natural or artificial pozzolan, shale, or granulated blast furnace slag, and between about 15-90% Portland cement clinker.

In some embodiments of the CCBC provided herein, the compositions comprise by weight between about 10-50% of the blend comprising the vaterite particles and the GCC particles (particle sizes, amounts, ratios, and/or surface areas are described herein), between about 10-35% aluminosilicate material, and between about 15-90% Portland cement clinker.

In some embodiments of the CCBC provided herein, the compositions comprise by weight between about 10-50% of the blend comprising the vaterite particles and the GCC particles (particle sizes, amounts, ratios, and/or surface areas are described herein), between about 10-35% calcined clay, between about 15-90% Portland cement clinker, and between about 0.1-5% gypsum or lithium carbonate.

In some embodiments of the CCBC provided herein, the composition after setting and hardening has a 28-day compressive strength of at least 21 MPa.

In some embodiments, the CCBC provided herein in wet or dried form may further include one or more plasticizers. Examples of plasticizers include, without limitation, polycarboxylate based superplasticizers, MasterGlenium 7920, MasterGlenium 7500, Fritz-Pak Supercizer PCE, sodium salt of poly(naphthalene sulfonic acid), Fritz-Pak Supercizer 5, and the like.

In some embodiments, the CCBC comprising the blend comprising the vaterite particles and the GCC particles may further include one or more admixtures to impart one or more properties to the product including, but not limited to, strength, flexural strength, compressive strength, porosity, thermal conductivity, etc. The amount of admixture that is employed may vary depending on the nature of the admixture. In some embodiments, the amount of the one or more admixtures ranges from 0.1 to 10% w/w. Examples of the admixture include, but not limited to, set accelerator, set retarder, air-entraining agent, foaming agent, defoamer, alkali-reactivity reducer, bonding admixture, dispersant, coloring admixture, corrosion inhibitor, damp-proofing admixture, gas former, permeability reducer, pumping aid, shrinkage compensation admixture, fungicidal admixture, germicidal admixture, insecticidal admixture, rheology modifying agent, finely divided mineral admixture, pozzolan, aggregate, wetting agent, strength enhancing agent, water repellent, reinforced material such as fiber, and any other admixture. When using an admixture, the blend to which the admixture raw material is introduced, is mixed for sufficient time to cause the admixture raw material to be dispersed relatively uniformly throughout the composition.

In some embodiments, the CCBC comprising the blend comprising the vaterite particles and the GCC particles may further include reinforcing material such as fiber, e.g., where fiber-reinforced product is desirable. Fiber can be made of zirconia containing material, aluminum, glass, steel, carbon, ceramic, grass, bamboo, wood, fiberglass, or synthetic material, e.g., polypropylene, polycarbonate, polyvinyl chloride, polyvinyl alcohol, nylon, polyethylene, polyester, rayon, high-strength aramid, (i.e., Kevlar©), or mixtures thereof.

In some embodiments, the blend comprising the vaterite particles and the GCC particles, and/or the calcium carbonate blend composition comprising the blend (and optionally the other components), further comprises inorganic additive and/or organic additive. In some embodiments, the inorganic additive or the organic additive in the compositions provided herein can be any additive that activates reactive vaterite.

Some examples of the inorganic additive or the organic additive in the compositions provided herein, include, but not limited to, fatty acid ester, sodium decyl sulfate, lauric acid, sodium salt of lauric acid, urea, citric acid, sodium salt of citric acid, phthalic acid, sodium salt of phthalic acid, taurine, creatine, dextrose, poly(n-vinyl-1-pyrrolidone), aspartic acid, sodium salt of aspartic acid, magnesium chloride, acetic acid, sodium salt of acetic acid, glutamic acid, sodium salt of glutamic acid, strontium chloride, gypsum, lithium chloride, sodium chloride, glycine, sodium citrate dehydrate, sodium bicarbonate, magnesium sulfate, magnesium acetate, sodium polystyrene, sodium dodecylsulfonate, poly-vinyl alcohol, or combination thereof. In some embodiments, the inorganic additive or the organic additive in the compositions provided herein, include, but not limited to, taurine, creatine, poly(n-vinyl-1-pyrrolidone), lauric acid, sodium salt of lauric acid, urea, magnesium chloride, acetic acid, sodium salt of acetic acid, strontium chloride, magnesium sulfate, magnesium acetate, or combination thereof. In some embodiments, the inorganic additive or the organic additive in the compositions provided herein, include, but not limited to, magnesium chloride, magnesium sulfate, magnesium acetate, or combination thereof.

In one aspect, there is provided concrete mix comprising any of the foregoing CCBC comprising the blend comprising the vaterite particles and the GCC particles. The “concrete” as used herein includes water, aggregate (e.g., rock, sand, or gravel) and the cement composition provided herein.

In one aspect, there is provided mortar mix comprising any of the foregoing CCBC comprising the blend comprising the vaterite particles and the GCC particles. The “mortar” as used herein includes water, sand, and the cement compositions provided herein.

In one aspect, there is provided calcium carbonate blend paste or calcium carbonate blend slurry composition, comprising a blend comprising vaterite particles having an average particle size of between about 0.1-50 μm and GCC particles having an average particle size of between about 1-150 μm, and water, and optionally interlocking acicular shaped aragonite, calcite, carboaluminate, or combination thereof.

In some embodiments, the aforementioned cement paste or cement slurry further comprises one or more of other components described herein.

### II. Methods and Systems

Methods and Systems to Form Cement Products and/or Non-Cement Products

Disclosed herein are methods and systems to form the cement products and/or the non-cement products from the calcium carbonate blend compositions provided herein. The cement product or the non-cement product may be formed from the calcium carbonate blend composition comprising the blend comprising the vaterite particles and the GCC particles. In some embodiments, the vaterite particles may be the stable vaterite particles or the reactive vaterite particles. In some embodiments, the calcium carbonate blend composition comprising the blend comprising the stable vaterite particles and the GCC particles optionally further comprising the other components (other components have been described herein), when mixed with the water may not result in the transformation of the vaterite particles. For example, the stable vaterite particles may stay as is and may act as the filler or the alternative SCM. In some embodiments, the blend comprising the stable vaterite particles and the GCC particles optionally further comprising the other components, may be used as the filler in the non-cement product. Various examples of the non-cement product have been described herein.

Various examples of the other component have been provided herein and include, without limitation, aluminosilicate material, slag from metal production, Portland cement clinker, calcium aluminate cement clinker, calcium sulfoaluminate cement clinker, carbonate material, alkali metal accelerator, alkaline earth metal accelerator, admixture, additive, or combination thereof. Various other components have been described in detail herein. It is to be understood that the list of the other components provided herein only provides few examples and various materials with the properties similar to the other components known in the art are equally applicable to the compositions provided herein.

In some embodiments, the calcium carbonate blend composition comprising the blend comprising the reactive vaterite particles and the GCC particles optionally further comprising the other components (the other components have been described herein), when mixed with the water results in the transformation of the reactive vaterite particles. For example, the reactive vaterite particles may transform upon the dissolution re-precipitation in the water to form the aragonite, the calcite, or the combination thereof.

In some embodiments, when the other component is the aluminosilicate material, the dissolution re-precipitation in the water may result in the formation of the carboaluminate (as described herein). In some embodiments, the aragonite, the calcite, the carboaluminate, or the combination thereof (obtained from the transformation of the reactive vaterite particles) may set and harden to form the cement product. Various examples of the cement product have been described herein.

The cement product or the non-cement product in addition to comprising the stable vaterite particles or the transformed reactive vaterite particles (transformed to the aragonite, the calcite, the carboaluminate, or the combination thereof) further comprise the GCC particles. In some embodiments, the cement product and/or the non-cement product comprise the interlocking acicular shaped aragonite, the calcite, and/or the carboaluminate further comprising the GCC particles. During the cementation process, e.g., in hydraulic cement systems, such as PC, both the vaterite and GCC may get covered and surrounded by calcium silicate hydrate and other hydration products, such as ettringite, portlandite, and/or carboaluminate. In some embodiments, during the dissolution reprecipitation of the reactive vaterite, the GCC and the vaterite get surrounded by calcite and/or interlocking acicular shaped aragonite. As the vaterite dissolves, it may then leave behind a hollow space that may in part be filled by the aragonite and/or the calcite further including the GCC. In some embodiments, it may be the initial encapsulation and surface nucleation of the calcite and/or the aragonite, that may set up the honeycomb microstructure.

Also disclosed herein are the methods and systems to form the cement product with varying bulk densities comprising the interlocking acicular shaped aragonite, the calcite, and/or the carboaluminate further comprising the GCC particles. The “interlocking acicular shaped aragonite” as used herein, includes acicular shaped aragonite that randomly interlock. In some embodiments, the acicular shaped aragonite grows from the surface of the reactive vaterite during the transformation. In some embodiments, the interlocking acicular shaped aragonite provides high shear resistance thereby providing high compressive strength and durability.

In some embodiments of the methods and systems described herein, the transformation of the reactive vaterite to form the aragonite, the calcite, or the combination thereof results in the formation of the cement product and/or the non-cement product with unique morphology of the interlocking acicular shaped aragonite microstructure and/or the calcite matrix that provides unique lightness, durability, and strength to the cement product and/or the non-cement product. For example, the interlocking acicular shaped aragonite structure and/or the calcite matrix may form one or more voids optionally forming a honeycomb structure as illustrated, for example, in FIG. 6 and described in Example 1 herein.

The varying packing densities or the bulk densities may be achieved by selecting unique compositions of the vaterite particles and the GCC particles optionally comprising other component(s) which after mixing in water and after curing result in the cement products comprising interlocking acicular shaped aragonite and/or the calcite matrix that optionally surrounds one or more voids. The one or more voids along with the surrounding acicular shaped aragonite and/or the calcite matrix forms a honeycomb structure (with acicular radiating outwards from the reactive vaterite sphere or its prior location) which provides porosity or lightweight to the cement product (lowering the packing density or the bulk density). The unique compositions of the vaterite particles and the GCC particles that result in the cement products with varying bulk densities have been provided herein.

In one aspect, there is provided method to form cement product, comprising adding water to the calcium carbonate blend composition provided herein comprising blend comprising vaterite particles having an average particle size of between about 0.1-50 μm and GCC particles having an average particle size of between about 1-150 μm; forming the wet composition and/or the slurry composition; and curing the cement product. In some embodiments, the blend may be mixed with the other components before adding water to the calcium carbonate blend composition.

In some embodiments of the above noted aspect, when the blend comprises reactive vaterite particles, the method further comprises transforming the reactive vaterite particles into the interlocking acicular shaped aragonite and/or the calcite matrix to form the cement product. In some embodiments of the aforementioned aspect, the cement product is of varying bulk density.

In some embodiments of the above noted aspect, when the blend comprises stable vaterite particles, the method further comprises mixing the blend with the other components, such as, but not limited to, Portland cement, aluminosilicate material, slag from metal production, Portland cement clinker, calcium aluminate cement clinker, and/or calcium sulfoaluminate cement clinker, where the blend comprising the stable vaterite particles and the GCC particles acts as the filler or the alternative SCM in the cement composition.

In some embodiments, systems have been provided herein that are configured to carry out the methods described herein. In one aspect, the systems provided herein comprise a blend station configured for forming the blend comprising the vaterite particles and the GCC particles and forming the calcium carbonate blend composition comprising the blend. In some embodiments, the blend station is configured for forming the blend comprising the vaterite particles having an average particle size of between about 0.1-50 μm and the GCC particles having an average particle size of between about 1-150 μm and forming the calcium carbonate blend composition comprising the blend.

In some embodiments of the above noted aspect, the systems provided herein may further comprise a mixer system configured to mix the blends provided herein with the other components to form the compositions suitable for forming the cement product and/or the non-cement product.

In some embodiments of the above noted aspect, the blend station or the mixer system is configured to form the dry powder calcium carbonate blend composition and/or is configured to form the wet or the slurry form of the calcium carbonate blend composition.

In some embodiments, the mixer system or the blend station is configured to prepare the wet composition or the slurry composition by adding water to the calcium carbonate blend composition and comprises rotary mixer, static mixer, pin mixer, Hobart mixer, slant cylinder mixer, Omni Mixer, Henschel mixer, V-type mixer, or Nauta mixer. Such mixers are commercially known in the art.

In some embodiments, the blend comprising the vaterite particles and the GCC particles further comprises aragonite particles. In some embodiments, the aragonite particles may be produced along with the vaterite particles during the production of the vaterite composition and/or the aragonite particles are added to the vaterite composition or the blend and/or to the water used to make the wet composition and/or to the wet composition itself. In some embodiments, the aragonite particles act as a seed to transform the reactive vaterite particles into the interlocking acicular shaped aragonite and/or the calcite matrix during and/or after the curing.

In some embodiments, the water-to-blend ratio may affect the packing densities or the bulk densities of the cement product. In some embodiments, the water-to-blend ratio is between about 0.1:1 to 1.2:1; or between about 0.1:1 to 1:1; or between about 0.1:1-0.5:1.

In some embodiments, depending on the water-to-blend ratio and additives used, the average particle size, and/or the particle distribution of the blend comprising vaterite particles and the GCC particles, the porosity of the cement product may be controlled to be between about 10%-90% and/or bulk density of between about 25-110 lb/ft³. For example only, when the cement product is aggregate, the aggregate is lightweight aggregate having porosity of between about 10-90% and/or bulk density of between about 25-75 lb/ft³.

After the formation of the cement product, the product may be cured by providing one or more of curing conditions such as, but not limited to, pressure, heat, and/or humidity. In some embodiments, the curing conditions facilitate transformation of the reactive vaterite in the blend into the interlocking acicular shaped aragonite, and/or the calcite, and/or the carboaluminate to form the set and hardened cement product. The systems used for curing include any commercially known curing system in the art, such as, but not limited to autoclave, heated conveyer belt, and/or curing chamber. In some embodiments, the pressure during curing is between about 10-10,000 psi; heat is between about 20-150° C.; and/or humidity is between about 40-100% relative humidity (RH). These ranges may vary depending on the constitution of the cement product including its water content or the desired bulk density.

In some embodiments of the foregoing embodiments, the pressure is between about 10-100,000 psi, or between about 10-75,000 psi, or between about 10-50,000 psi, or between about 10-25,000 psi, or between about 10-10,000 psi, or between about 10-2,000 psi, or between about 10-1,000 psi, or between about 10-500 psi; heat is between about 20-300° C., or between about 20-200° C., or between about 20-150° C., or between about 20-125° C., or between about 20-100° C., or between about 20-75° C., or between about 20-50° C., or between about 40° C.-60° C., or between about 40° C.-50° C., or between about 40° C.-100° C., or between about 50° C.-60° C., or between about 50° C.-80° C., or between about 50° C.-100° C., or between about 60° C.-80° C., or between about 60° C.-100° C.; and/or humidity is between about 40-100% RH, or between about 40-75% RH, or between about 40-50% RH, or between about 50-75% RH, or 40%, or 50%, or 60%, or 70%, or 90%, or 98% RH.

In some embodiments of the foregoing embodiments, the pressure is between about 10-1,000 psi, or between about 10-500 psi, or between about 10-100 psi; heat is between about 40-150° C., or between about 40-95° C., or between about 60-80° C., or between about 75-100° C., or between about 100-150° C.; and/or humidity is between about 75-100% RH, or between about 80-100% RH, or between about 90-100% RH, or 100% RH.

In some embodiments, the curing system provides heat and humidity in the form of steam to the calcium carbonate blend composition. The combination of the curing conditions, such as the pressure, the temperature, the relative humidity, and the time of exposure, etc., can be varied according to the size and constitution of the cement product and the desired result.

During the curing process of the cement product, in some embodiments, the reactive vaterite particles in the wet calcium carbonate blend composition may dissolve in water and reprecipitate into the interlocking acicular shaped aragonite and/or the calcite instead of participating in the actual cementing reactions like traditional cements. Therefore, the water may remain in the cement product after the cementing reaction is completed and the interlocking acicular shaped aragonite and/or the calcite matrix is formed. The water after evaporation and drying may leave porosity or one or more voids. Further, the vaterite has a lower specific gravity than the aragonite and it is contemplated that the transformation from the reactive vaterite to the interlocking acicular shaped aragonite may leave extra pore space or voids in the matrix. In some embodiments, the unique interlocking acicular shaped aragonite and/or the calcite matrix in the cement product surround the one or more voids left behind by the dissolution of the reactive vaterite particles, forming the honeycomb structure. The unique honeycomb structure with one or more voids surrounded by the interlocking acicular shaped aragonite and/or the calcite matrix reduces the bulk density of the cement product and the unique interlocking acicular shaped aragonite and/or the calcite matrix provides high compressive strength and durability. As described herein, water to the blend ratio, average particle size and the particle distribution of the blend composition comprising the vaterite particles and the GCC particles influences the packing density or the bulk density of the cement product and therefore, cement product with varying bulk densities may be formed by selecting unique combinations of the water to the blend ratio, the average particle size and the particle distribution of the blend composition comprising the vaterite and the GCC particles. As described herein, in some embodiments, the blend comprising the vaterite particles having an average particle size of between about 0.1-50 μm and the GCC particles having an average particle size of between about 1-150 μm pack together in the cement and result in a unique morphology of the interlocking acicular shaped aragonite and/or the calcite matrix containing the GCC particles surrounding the one or more voids and forming the honeycomb like structure.

In some embodiments, the aggregate formed by the methods and systems described herein has porosity of between about 10-90%; has bulk density of between about 25-110 lb/ft³; has Mohs hardness of less than 6; and/or has an abrasion resistance of less than 50%.

In some embodiments, the methods and systems described herein further comprise forming the cement product of bulk density between about 25-65 lb/ft³ when the vaterite has spherical morphology; and has a specific surface area of between about 200-40,000 m²/kg; and the GCC particles have an average particle size of between about 1-150 μm having a specific surface area of between about 100-10,000 m²/kg.

In some embodiments, the methods and systems described herein further comprise forming the lightweight aggregate of bulk density between about 25-65 lb/ft³ when the vaterite particles have spherical morphology; and have a specific surface area of between about 200-40,000 m²/kg; and the GCC particles have an average particle size of between about 1-150 μm having a specific surface area of between about 100-10,000 m²/kg.

In some embodiments, the methods and systems described herein further comprise producing the vaterite particles before the preparing step. The methods and systems to produce the vaterite particles; to produce the corresponding blend comprising the vaterite particles and the GCC particles; and to produce the calcium carbonate blend composition comprising the blend, have been described further herein below.

### Methods and Systems to Produce Calcium Carbonate Blend Composition

In the methods and systems provided herein, the vaterite composition can be formed either by calcining limestone and/or by using limestone directly to form the composition comprising vaterite. The vaterite formed can be the stable vaterite and/or the reactive vaterite.

In one aspect there are provided methods for producing the calcium carbonate blend composition, comprising: (a) calcining the limestone to form the mixture comprising lime and the gaseous stream comprising carbon dioxide; (b) dissolving the mixture comprising lime in the N-containing salt solution to produce the aqueous solution comprising calcium salt; and (c) treating the aqueous solution comprising calcium salt with the gaseous stream comprising carbon dioxide to form the composition comprising vaterite particles; (d) blending the vaterite particles with the GCC particles to form the blend comprising the vaterite particles and the GCC particles; and (e) forming the calcium carbonate blend composition comprising the blend.

In one aspect there are provided methods for producing the calcium carbonate blend composition, comprising: (a) calcining the limestone to form the mixture comprising lime and the gaseous stream comprising carbon dioxide; (b) dissolving the mixture comprising lime in the N-containing salt solution to produce the aqueous solution comprising calcium salt; and (c) treating the aqueous solution comprising calcium salt with the gaseous stream comprising carbon dioxide to form the composition comprising vaterite particles having the average particle size of between about 0.1-50 μm; (d) blending the vaterite particles with the GCC particles to form the blend comprising the vaterite particles having the average particle size of between about 0.1-50 μm and the GCC particles having the average particle size of between about 1-150 μm; and (e) forming the calcium carbonate blend composition comprising the blend.

In one aspect there are provided methods for producing the calcium carbonate blend composition, comprising: (a) dissolving the limestone in the N-containing salt solution to produce the aqueous solution comprising calcium salt and the gaseous stream comprising carbon dioxide; and (b) treating the aqueous solution comprising calcium salt with the gaseous stream comprising carbon dioxide to form the composition comprising vaterite particles; (c) blending the vaterite particles with the GCC particles to form the blend comprising the vaterite particles and the GCC particles; and (d) forming the calcium carbonate blend composition comprising the blend.

In one aspect there are provided methods for producing the calcium carbonate blend composition, comprising: (a) dissolving the limestone in the N-containing salt solution to produce the aqueous solution comprising calcium salt and the gaseous stream comprising carbon dioxide; and (b) treating the aqueous solution comprising calcium salt with the gaseous stream comprising carbon dioxide to form the composition comprising vaterite particles having the average particle size of between about 0.1-50 μm; (c) blending the vaterite particles with the GCC particles to form the blend comprising the vaterite particles having the average particle size of between about 0.1-50 μm and the GCC particles having the average particle size of between about 1-150 μm; and (d) forming the calcium carbonate blend composition comprising the blend.

In the methods and systems provided herein, the vaterite is the reactive vaterite, the stable vaterite, or combination thereof. Both the reactive vaterite and the stable vaterite have been described in detail herein. In some embodiments, the composition comprising vaterite may further comprise aragonite, calcite, or combination thereof. Accordingly, in some embodiments, the blend comprising the vaterite particles and the GCC particles, further comprises aragonite, calcite, or combination thereof. In some embodiments, the blend comprising the vaterite particles and the GCC particles, either alone or mixed with the other components (the other components have been described herein), forms the calcium carbonate blend composition. It is to be understood that the blend comprising the vaterite particles and the GCC particles, can be a self-cement (cementitious in itself) or may be mixed with other cement materials (e.g., the other components) such as, but not limited to, PC, calcium aluminate cement, calcium sulfoaluminate cement and/or clinker thereof, etc. In some embodiments, when the vaterite is the stable vaterite, the vaterite may not transform into the aragonite and/or the calcite and may be used as the filler in several products. For example, the stable vaterite may be used as the alternative SCM in the other components such as the PC, and/or may be used as the filler in the cement or the non-cement product.

In one aspect there are provided systems, comprising:
(i) a calcining reactor configured to calcine the limestone to form the mixture comprising lime and the gaseous stream comprising carbon dioxide;
(ii) a dissolution reactor operably connected to the calcination reactor configured for dissolving the mixture comprising lime in the aqueous N-containing salt solution to produce the aqueous solution comprising calcium salt;
(iii) a treatment reactor operably connected to the dissolution reactor configured for treating the aqueous solution comprising calcium salt with the gaseous stream comprising carbon dioxide to form the composition comprising vaterite particles having the average particle size of between about 0.1-50 μm; and
(iv) a blending station operably connected to the treatment reactor and configured for forming the blend comprising the vaterite particles having the average particle size of between about 0.1-50 μm and the GCC particles having the average particle size of between about 1-150 μm and forming the calcium carbonate blend composition comprising the blend.

In one aspect there are provided systems, comprising:
(i) a dissolution reactor configured for dissolving the limestone with the N-containing salt solution to produce the aqueous solution comprising calcium salt and the gaseous stream comprising carbon dioxide;
(ii) the treatment reactor operably connected to the dissolution reactor configured for treating the aqueous solution comprising calcium salt with the gaseous stream comprising carbon dioxide to form the composition comprising vaterite particles having the average particle size of between about 0.1-50 μm; and
(iii) the blending station operably connected to the treatment reactor and configured for forming the blend comprising the vaterite particles having the average particle size of between about 0.1-50 μm and the GCC particles having the average particle size of between about 1-150 μm and forming the calcium carbonate blend composition comprising the blend.

In some embodiments of the foregoing system aspects and embodiments, the system further comprises a mixer system configured to mix one or more of the other components to the blend and form the calcium carbonate blend composition comprising the blend and the one or more of the other components.

In some embodiments of the foregoing system aspects and embodiments, the system further comprises a mixer system configured to prepare a wet calcium carbonate blend composition by adding water to the calcium carbonate blend composition; and a curing system configured to cure the wet calcium carbonate blend composition to transform the reactive vaterite particles into the interlocking acicular shaped aragonite and/or the calcite, and/or the carboaluminate to form the cement product.

In some embodiments of the foregoing aspects and embodiments, the mixer system is rotary mixer, static mixer, pin mixer, Hobart mixer, slant cylinder mixer, Omni Mixer, Henschel mixer, V-type mixer, or Nauta mixer. In some embodiments of the foregoing aspects and embodiments, the curing system is one or more autoclaves. In some embodiments of the foregoing aspects and embodiments, the system further comprises a control system configured to remotely and/or automatedly control the components of the systems.

In some embodiments of the foregoing aspects and embodiments, the system further comprises a transfer system operably connected to the treatment reactor of the system and the mixer system and/or the blending station and is configured to transfer the composition from the treatment reactor to the mixer system and/or the blending station.

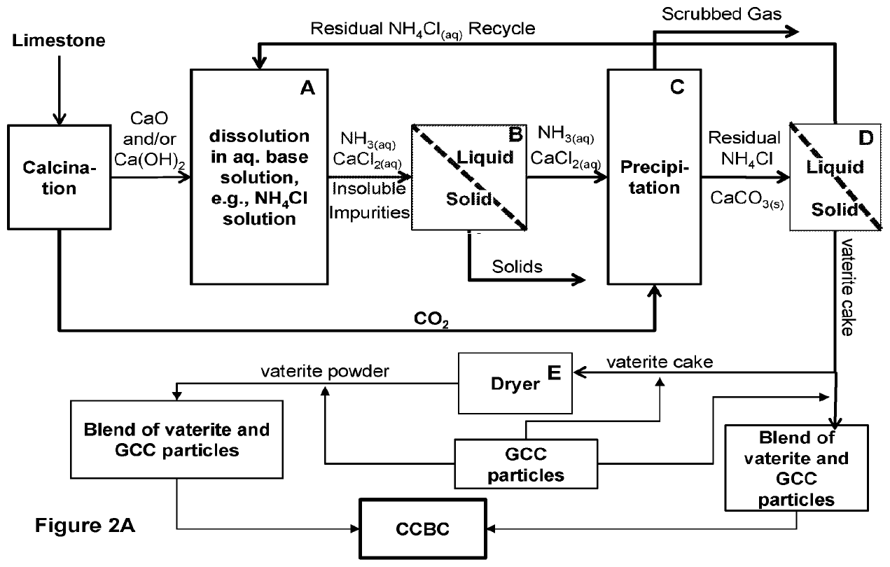

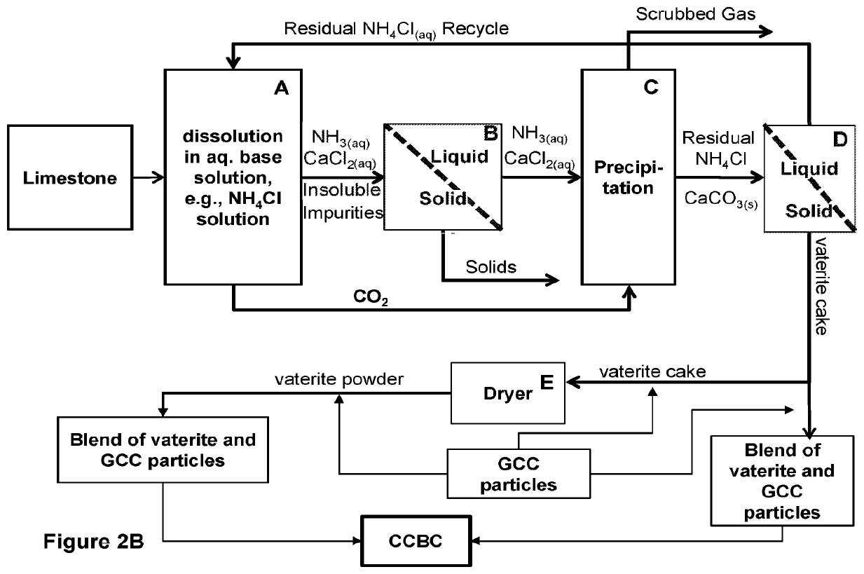

The calcium carbonate blend composition can be prepared using various methods and systems, as described further herein and illustrated in FIGS. 2A, 2B, 3A, 3B, 4A, and 4B. The calcium carbonate blend composition is being represented as CCBC in the figures provided herein. The calcium carbonate blend composition can be produced using the limestone as the feedstock where the limestone is used as is in the process or is calcined to form the lime. The methods and systems provided herein to produce the calcium carbonate blend composition have several advantages, such as but not limited to, reduction of carbon dioxide emissions through the incorporation of the carbon dioxide back into the process to form the calcium carbonate blend composition. Production of the calcium carbonate blend composition, in the methods and systems provided herein, offers advantages including, operating expense savings through the reduction in fuel consumption, and reductions in carbon footprint. In the methods and systems provided herein, the emissions of the CO₂ from the calcination of the limestone to the lime may be avoided by recapturing it back in the vaterite material. By recapturing the carbon dioxide, the cement and/or the non-cement products have the potential to eliminate significant amount of the carbon dioxide emissions and total global emissions from all sources. This calcium carbonate blend composition provided herein can be used as a self-cement (when the reactive vaterite transforms to the aragonite and/or the calcite and sets and hardens) and/or to replace cement materials, such as, e.g., Portland Cement (PC) or Portland cement clinker or calcium aluminate cement clinker, and/or calcium sulfoaluminate cement clinker, etc. either entirely or partially as the filler or the alternative SCM.

In some embodiments, the limestone can be used directly to form the calcium carbonate blend composition (as illustrated in FIGS. 2B, 3B, and 4B) or the limestone may be calcined to form the lime which may be used to form the calcium carbonate blend composition (as illustrated in FIGS. 2A, 3A, and 4A). The aforementioned aspects and embodiments of the methods and systems provided herein are as illustrated in FIGS. 2A, 2B, 3A, 3B, 4A, and 4B. It is to be understood that the steps illustrated in the figures may be modified or the order of the steps may be changed or more steps may be added or deleted depending on the desired outcome.

The calcination or the calcining is a thermal treatment process to bring about a thermal decomposition of the limestone. The “limestone” as used herein, means CaCO₃ and may further include other impurities typically present in the limestone. In some embodiments, the limestone further comprises magnesium or magnesium oxide. Limestone is a naturally occurring mineral. The chemical composition of this mineral may vary from region to region as well as between different deposits in the same region. Therefore, the lime containing the calcium oxide and/or the calcium hydroxide obtained from calcining limestone from each natural deposit may be different. The limestone may be composed of calcium carbonate (CaCO₃), magnesium, e.g., magnesium carbonate (MgCO₃), silica (SiO₂), alumina (Al₂O₃), iron (Fe), sulfur (S) or other trace elements.

The limestone deposits are widely distributed. The limestone from the various deposits may differ in physical chemical properties and can be classified according to their chemical composition, texture, and geological formation. The limestone may be classified into the following types: high calcium limestone where the carbonate content may be composed mainly of the calcium carbonate with the magnesium carbonate content not more than 5%; magnesium limestone containing magnesium carbonate to about 5-35%; or dolomitic limestone which may contain between 35-46% of MgCO₃, the balance amount is calcium carbonate. The limestone from different sources may differ considerably in chemical compositions and physical structures. It is to be understood that the methods and systems provided herein apply to all the cement plants calcining the limestone from any of the sources listed above or commercially available. The quarries include, but not limited to, quarries associated with cement kilns, quarries for lime rock for aggregate for use in concrete, quarries for lime rock for other purposes (road base), and/or quarries associated with lime kilns.

The limestone calcination is a decomposition process where the chemical reaction for decomposition of the limestone is:

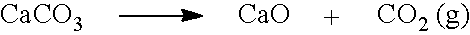

This step is illustrated in FIGS. 2A, 3A, and 4A as a first step of the calcination of the limestone to form the lime. However, in some embodiments, the calcination step can be obviated, and the limestone is used directly as a feed stock (FIGS. 2B, 3B, and 4B).

In some embodiments, the limestone comprises between about 1-70% magnesium and/or a magnesium bearing mineral is mixed with the limestone before the calcination wherein the magnesium bearing mineral comprises between about 1-70% magnesium. In some embodiments, the magnesium upon the calcination forms the magnesium oxide which may be precipitated and/or incorporated in the vaterite once formed. In some embodiments, the magnesium bearing mineral comprises magnesium carbonate, magnesium salt, magnesium hydroxide, magnesium silicate, magnesium sulfate, or combinations thereof. In some embodiments, the magnesium bearing mineral includes, but not limited to, dolomite, magnesite, brucite, carnallite, talc, olivine, artinite, hydromagnesite, dypingite, barringonite, nesquehonite, lansfordite, kieserite, and combinations thereof. In some embodiments, the magnesium oxide in the vaterite composition when comes into contact with water, transforms to magnesium hydroxide which may bind with the transformed aragonite and/or the calcite.

The “lime” as used herein relates to calcium oxide and/or calcium hydroxide. The presence and amount of the calcium oxide and/or the calcium hydroxide in the lime would vary depending on the conditions for the lime formation. The lime may be in dry form i.e., calcium oxide, and/or in wet form e.g., calcium hydroxide, depending on the conditions. The production of the lime may depend upon the type of kiln, conditions of the calcination, and the nature of the raw material i.e., the limestone. At relatively low calcination temperatures, products formed in the kiln may contain both un-burnt carbonate and lime and may be called underburnt lime. As the temperature increases, soft burnt or high reactive lime may be produced. At still higher temperatures, dead burnt or low reactive lime may be produced. Soft burnt lime is produced when the reaction front reaches the core of the charged limestone and converts all carbonate present to the lime. A high productive product may be relatively soft, contains small lime crystallites and has open porous structure with an easily assessable interior. Such lime may have the optimum properties of high reactivity, high surface area and low bulk density. Increasing the degree of calcination beyond this stage may make the lime crystallites to grow larger, agglomerate and sinter. This may result in a decrease in surface area, porosity and reactivity and an increase in bulk density. This product may be known as dead burnt or low reactive lime. Without being limited by any theory, the methods and systems provided herein utilize any one or the combination of the aforementioned lime. Therefore, in some embodiments, the lime is dead burnt, soft burnt, underburnt, or combinations thereof.

Production of the lime by calcining the limestone may be carried out using various types of kilns, such as, but not limited to, a shaft kiln or a rotary kiln or an electric kiln. The use of the electric kiln in the calcination and the advantages associated with it, have been described in U.S. application Ser. No. 17/363,537, filed Jun. 30, 2021, which is fully incorporated herein by reference in its entirety.

These apparatuses for the calcining are suitable for calcining the limestone in the form of lumps having diameters of several to tens millimeters. Cement plant waste streams include waste streams from both wet process and dry process plants, which plants may employ shaft kilns, rotary kilns, electric kilns, or combinations thereof and may include pre-calciners. These industrial plants may each burn a single fuel or may burn two or more fuels sequentially or simultaneously.

As illustrated in FIGS. 2A, 2B, 3A, 3B, 4A, and 4B, the limestone obtained from the limestone quarry is subjected to the calcination in a cement plant resulting in the formation of the lime and CO₂ gas or is used directly. The lime may be calcium oxide in the form of a solid from dry kilns/cement processes and/or may be a combination of calcium oxide and calcium hydroxide in the form of slurry in wet kilns/cement processes. When wet the calcium oxide (also known as a base anhydride that converts to its hydroxide form in water) may be present in its hydrated form such as but not limited to, calcium hydroxide. While calcium hydroxide (also called slaked lime) is a common hydrated form of calcium oxide, other intermediate hydrated and/or water complexes may also be present in the slurry and are all included within the scope of the methods and systems provided herein. It is to be understood that while the lime is illustrated as CaO in some of the figures herein, it may be present as Ca(OH)₂ or combination of CaO and Ca(OH)₂.

The lime or the limestone may be sparingly soluble in water. In the methods and systems provided herein, the lime or the limestone solubility is increased by its treatment with solubilizers.

In the methods and systems provided herein, the lime or the limestone is solvated or dissolved or solubilized with the solubilizer, such as a weak acid solution (step A in FIGS. 2A, 2B, 3A, 3B, 4A, and 4B) to produce the aqueous solution comprising calcium salt. For illustration purposes only, the weak acid solution, e.g., N-containing salt solution is being illustrated in the figures as ammonium chloride (NH₄Cl) solution and the subsequent calcium salt is being illustrated as calcium chloride (CaCl₂)). Various examples of the N-containing salt have been provided herein and are all within the scope of the invention.

In some embodiments, the N-containing salt solution solubilizes or dissolves the calcium from the lime or the limestone and leaves the solid impurities. The N-containing salt include without limitation, N-containing inorganic salt, N-containing organic salt, or combination thereof.

The “N-containing inorganic salt” as used herein includes any inorganic salt with nitrogen in it. Examples of N-containing inorganic salt include, but not limited to, ammonium halide (halide is any halogen), ammonium acetate, ammonium sulfate, ammonium sulfite, ammonium nitrate, ammonium nitrite, and the like. In some embodiments, the ammonium halide is ammonium chloride or ammonium bromide. In some embodiments, the ammonium halide is ammonium chloride.

The “N-containing organic salt” as used herein includes any salt of an organic compound with nitrogen in it. Examples of N-containing organic compounds include, but not limited to, aliphatic amine, alicyclic amine, heterocyclic amine, and combinations thereof.

The “aliphatic amine” as used herein includes any alkyl amine of formula (R)ₙ—NH₃₋ₙ where n is an integer from 1-3, wherein R is independently between C1-C8 linear or branched and substituted or unsubstituted alkyl. An example of the corresponding halide salt (chloride salt, bromide salt, fluoride salt, or iodide salt) of the alkyl amine of formula (R)ₙ—NH₃₋ₙ is (R)ₙ—NH₄₋ₙ⁺Cl⁻. In some embodiments, when R is substituted alkyl, the substituted alkyl is independently substituted with halogen, hydroxyl, acid and/or ester.

For example, when R is alkyl in (R)ₙ—NH₃₋ₙ, the alkyl amine can be a primary alkyl amine, such as for example only, methylamine, ethylamine, butylamine, pentylamine, etc.; the alkyl amine can be a secondary amine, such as for example only, dimethylamine, diethylamine, methylethylamine, etc.; and/or the alkyl amine can be a tertiary amine, such as for example only, trimethylamine, triethylamine, etc.

For example, when R is substituted alkyl substituted with hydroxyl in (R)ₙ—NH₃₋ₙ, the substituted alkyl amine is an alkanolamine including, but not limited to, monoalkanolamine, dialkanolamine, or trialkanolamine, such as e.g., monoethanolamine, diethanolamine, or triethanolamine, etc.

For example, when R is substituted alkyl substituted with halogen in (R)ₙ—NH₃₋ₙ, the substituted alkyl amine is, for example, chloromethylamine, bromomethylamine, chloroethylamine, bromoethylamine, etc.

For example, when R is substituted alkyl substituted with acid in (R)ₙ—NH₃₋ₙ, the substituted alkyl amine is, for example, amino acids. In some embodiments, the aforementioned amino acid has a polar uncharged alkyl chain, examples include without limitation, serine, threonine, asparagine, glutamine, or combinations thereof. In some embodiments, the aforementioned amino acid has a charged alkyl chain, examples include without limitation, arginine, histidine, lysine, aspartic acid, glutamic acid, or combinations thereof. In some embodiments, the aforementioned amino acid is glycine, praline, or combination thereof.

The “alicyclic amine” as used herein includes any alicyclic amine of formula (R)ₙ—NH₃₋ₙ where n is an integer from 1-3, wherein R is independently one or more all-carbon rings which may be either saturated or unsaturated, but do not have aromatic character. Alicyclic compounds may have one or more aliphatic side chains attached. An example of the corresponding salt of the alicyclic amine of formula (R)ₙ—NH₃₋ₙ is (R)ₙ—NH₄₋ₙ⁺Cl⁻. Examples of alicyclic amine include, without limitation, cycloalkylamine: cyclopropylamine, cyclobutylamine, cyclopentylamine, cyclohexylamine, cycloheptylamine, cyclooctylamine, and so on.

The “heterocyclic amine” as used herein includes at least one heterocyclic aromatic ring attached to at least one amine. Examples of heterocyclic rings include, without limitation, pyrrole, pyrrolidine, pyridine, pyrimidine, etc. Such chemicals are well known in the art and are commercially available.

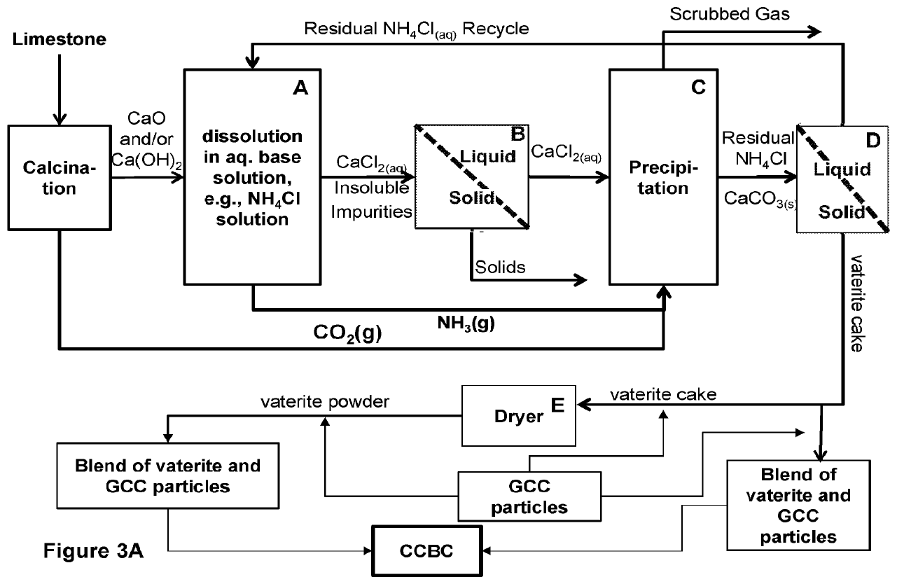

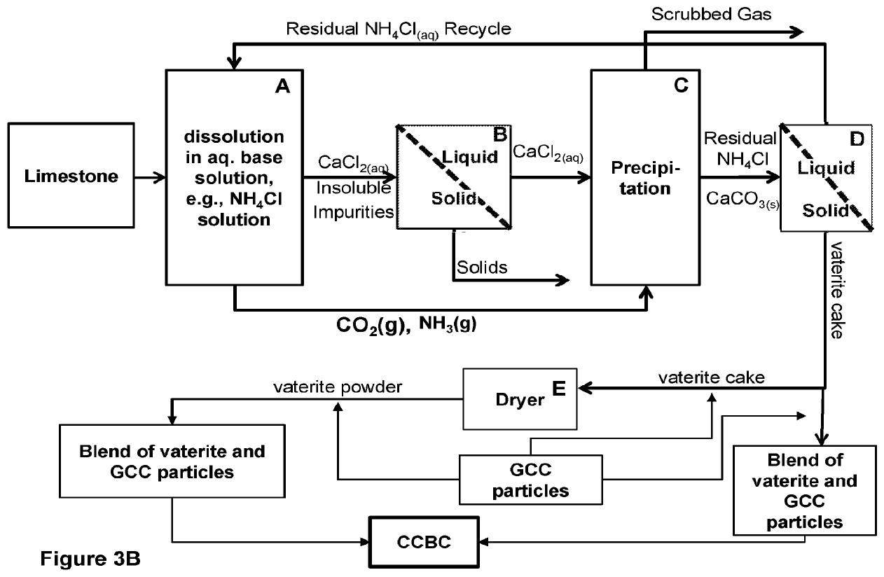

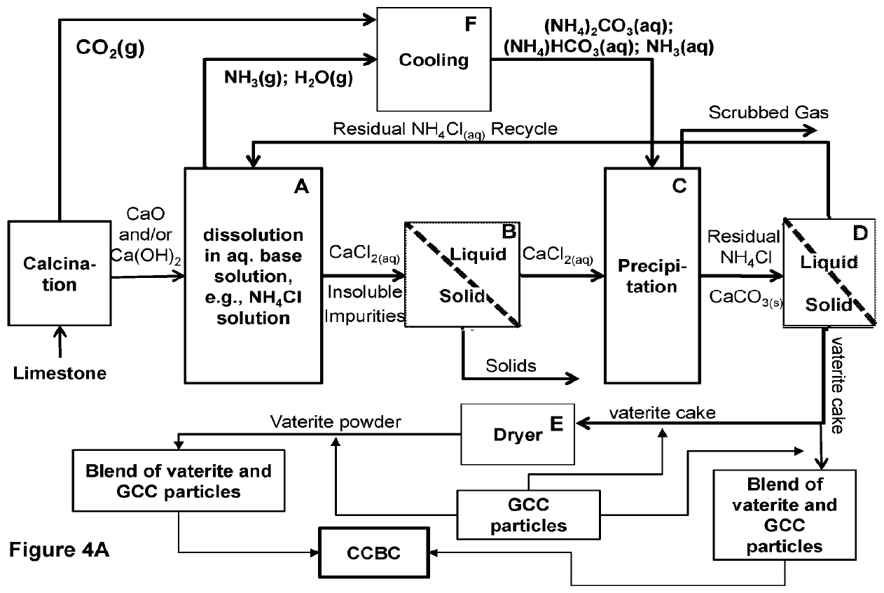

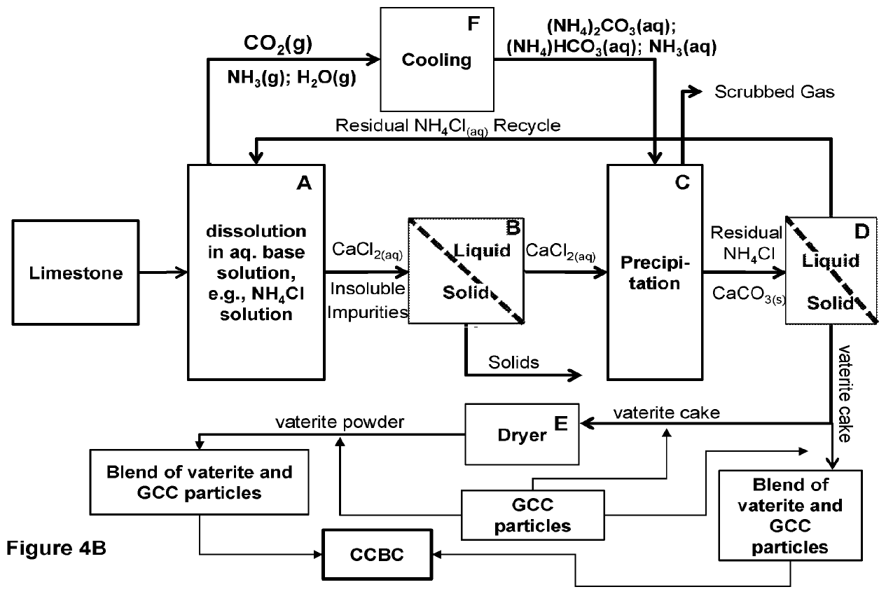

In the methods and systems provided herein, the limestone or the lime is dissolved or solubilized with the N-containing salt solution (step A) under one or more dissolution conditions to produce the aqueous solution comprising calcium salt. The dissolution step may form ammonia in the aqueous solution (illustrated in FIGS. 2A and 2B) and/or form the gaseous stream comprising ammonia gas (illustrated in FIGS. 3A, 3B, 4A, and 4B).

As illustrated in step A of FIGS. 2A, 3A, and 4A, the N-containing salt is exemplified as ammonium chloride (NH₄Cl). The lime is solubilized by treatment with the NH₄Cl (new and recycled as further explained below) when the reaction that may occur is:

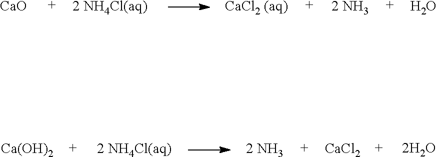

Similarly, when the N-containing salt is N-containing organic salt, the reaction may be shown as below:

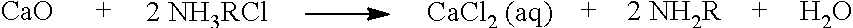

Similarly, illustrated in step A of FIGS. 2B, 3B, and 4B, the N-containing salt is exemplified as the ammonium chloride (NH₄Cl). The limestone is solubilized by treatment with the NH₄Cl (new and recycled as further explained below) when the reaction that may occur is:

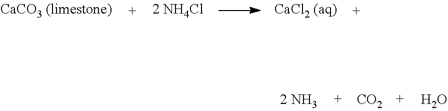

Similarly, when the base is N-containing organic salt, the reaction may be shown as below:

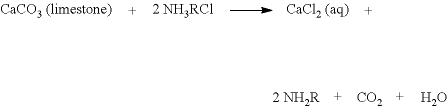

In some embodiments, the base or the N-containing inorganic salt such as, but not limited to, an ammonium salt, e.g., the ammonium chloride or the ammonium acetate solution may be supplemented with the anhydrous ammonia or the aqueous solution of ammonia to maintain an optimum level of the ammonium chloride in the solution.

In some embodiments, the aqueous solution comprising calcium salt obtained after dissolution of the lime or the limestone may contain sulfur depending on the source of the limestone. The sulfur may get introduced into the aqueous solution after the solubilization of the lime or the limestone with any of the N-containing salt described herein. In an alkaline solution, various sulfur compounds containing various sulfur ionic species may be present in the solution including, but not limited to, sulfite (SO₃²⁻), sulfate (SO₄²⁻), hydrosulfide (HS⁻), thiosulfate (S₂O₃²⁻), polysulfides (Sₙ²⁻), thiol (RSH), and the like. The “sulfur compound” as used herein, includes any sulfur ion containing compound.

In some embodiments, the aqueous solution further comprises the N-containing salt, such as, ammonia and/or N-containing inorganic or N-containing organic salt.

In some embodiments, the amount of the N-containing inorganic salt, the N-containing organic salt, or combinations thereof, is in more than 20% excess or more than 30% excess to the lime or the limestone. In some embodiments, the molar ratio of the N-containing salt:lime (or N-containing inorganic salt:lime or N-containing organic salt:lime or ammonium chloride lime or ammonium acetate:lime) or the molar ratio of the N-containing salt:limestone (or N-containing inorganic salt:limestone or N-containing organic salt:limestone or ammonium chloride:limestone or ammonium acetate:limestone) is between 0.5:1-2:1; or 0.5:1-1.5:1; or 1:1-1.5:1; or 1.5:1; or 2:1; or 2.5:1; or 1:1.

In some embodiments of the methods and systems described herein, one or more dissolution conditions are selected from the group consisting of temperature between about 30-200° C., or between about 30-150° C., or between about 30-100° C., or between about 30-75° C., or between about 30-50° C., or between about 40-200° C., or between about 40-150° C., or between about 40-100° C., or between about 40-75° C., or between about 40-50° C., or between about 50-200° C., or between about 50-150° C., or between about 50-100° C.; pressure between about 0.1-50 atm, or between about 0.1-40 atm, or between about 0.1-30 atm, or between about 0.1-20 atm, or between about 0.1-10 atm, or between about 0.5-20 atm; N-containing inorganic or organic salt wt % in water between about 0.5-50%, or between about 0.5-25%, or between about 0.5-10%, or between about 3-30%, or between about 5-20%; or combinations thereof.

Agitation may be used to affect dissolution of the lime or the limestone with the N-containing salt solution in the dissolution reactor, for example, by eliminating hot and cold spots to optimize the dissolution/salvation of the lime or the limestone, high shear mixing, wet milling, and/or sonication may be used to break open the lime or the limestone. During or after high shear mixing and/or wet milling, the lime or the limestone suspension may be treated with the N-containing salt solution.

In some embodiments, the dissolution of the lime or the limestone with the N-containing salt solution (illustrated as e.g., ammonium chloride) results in the formation of the aqueous solution comprising calcium salt and solid. In some embodiments, the solid insoluble impurities may be removed from the aqueous solution of the calcium salt (step B in FIGS. 2A, 2B, 3A, 3B, 4A, and 4B) before the aqueous solution is treated with the carbon dioxide in the process. The solid may optionally be removed from the aqueous solution by filtration and/or centrifugation techniques.

It is to be understood that the step B in FIGS. 2A, 2B, 3A, 3B, 4A, and 4B is optional and in some embodiments, the solid may not be removed from the aqueous solution (not shown in the figures) and the aqueous solution containing calcium salts as well as the solid is contacted with the carbon dioxide (in step C in FIGS. 2A, 2B, 3A, 3B, 4A, and 4B) to form the precipitate (or the composition comprising the vaterite). In such embodiments, the precipitation material further comprises solid.

In some embodiments, the solid obtained from the dissolution of the lime or the limestone (shown as insoluble impurities in FIGS. 2A, 2B, 3A, 3B, 4A, and 4B) is calcium depleted solid and may be used as a cement substitute (such as a substitute for Portland cement). In some embodiments, the solid comprises silicate, iron oxide, aluminate, or combination thereof. The silicate includes, without limitation, clay (phyllosilicate), alumino-silicate, etc.

In some embodiments, the solid is between about 1-85 wt %; or between about 1-80 wt %; or between about 1-75 wt %; or between about 1-70 wt %; or between about 1-60 wt %; or between about 1-50 wt %; or between about 1-40 wt %; or between about 1-30 wt %; or between about 1-20 wt %; or between about 1-10 wt % or between about 1-5 wt %; or between about 1-2 wt %, in the aqueous solution, in the precipitation material, in the composition, in the blend, in the calcium carbonate blend composition, or combinations thereof.

As illustrated in step C in FIGS. 2A, 2B, 3A, 3B, 4A, and 4B, the aqueous solution comprising calcium salt (and optionally solid) and dissolved ammonia and/or ammonium salt is contacted (e.g., under one or more precipitation conditions) with the gaseous stream comprising carbon dioxide recycled from the calcination step of the limestone calcination process or the dissolution step of the direct limestone process, to form the composition comprising vaterite particles, shown in the reaction below:

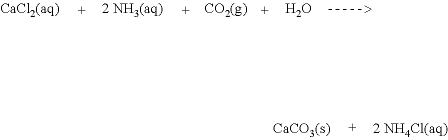

The absorption of the CO₂ into the aqueous solution produces CO₂-charged water containing carbonic acid, a species in equilibrium with both bicarbonate and carbonate. The precipitation material is prepared under one or more precipitation conditions (as described herein) suitable to form the vaterite material.

In one aspect, the ammonia formed in the dissolution step A may be partially or fully present in a gaseous form. This aspect is illustrated in FIGS. 3A and 3B.

In one aspect, there are provided methods to form the composition by (a) calcining the limestone to form the mixture comprising lime and the gaseous stream comprising carbon dioxide; (b) dissolving the mixture comprising lime in the N-containing salt solution to produce the aqueous solution comprising calcium salt, and the gaseous stream comprising ammonia; (c) treating the aqueous solution comprising calcium salt with the gaseous stream comprising carbon dioxide and the gaseous stream comprising ammonia to form the composition comprising vaterite particles; (d) blending the composition comprising vaterite particles with the GCC particles to form the blend comprising the vaterite particles and the GCC particles; and (e) forming the calcium carbonate blend composition comprising the blend. In some embodiments of the above noted aspect, the blend comprises the vaterite particles having an average particle size of between about 0.1-50 μm and the GCC particles having an average particle size of between about 1-150 μm.

This aspect is illustrated in FIG. 3A, wherein the gaseous stream comprising CO₂ from the calcination step and the gaseous stream comprising NH₃ from step A of the process is recirculated to the precipitation reactor (step C) for the formation of the vaterite precipitate. Remaining steps of FIG. 3A are identical to the steps of FIG. 2A. It is to be understood that the processes of both FIG. 2A and FIG. 3A can also take place simultaneously such that the N-containing salt, such as the N-containing inorganic salt or the N-containing organic salt and optionally ammonia may be partially present in the aqueous solution and partially present in the gaseous stream.

The reaction taking place in the aforementioned aspect may be shown as below:

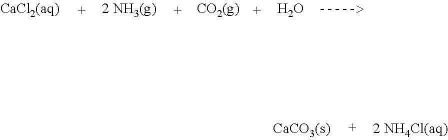

In one aspect, there are provided methods to form the composition by (a) dissolving the limestone in the N-containing salt solution to produce the aqueous solution comprising calcium salt, and the gaseous stream comprising ammonia and the gaseous stream comprising carbon dioxide; and (c) treating the aqueous solution comprising calcium salt with the gaseous stream comprising carbon dioxide and the gaseous stream comprising ammonia to form the composition comprising vaterite particles; (d) blending the composition comprising vaterite particles with the GCC particles to form the blend comprising the vaterite particles and the GCC particles; and (e) forming the calcium carbonate blend composition comprising the blend. In some embodiments of the above noted aspect, the blend comprises the vaterite particles having an average particle size of between about 0.1-50 μm and the GCC particles having an average particle size of between about 1-150 μm.

This aspect is illustrated in FIG. 3B, wherein the gaseous stream comprising CO₂ and the gaseous stream comprising NH₃ from step A of the process is recirculated to the precipitation reactor (step C) for the formation of the vaterite precipitate. Remaining steps of FIG. 3B are identical to the steps of FIG. 2B. It is to be understood that the processes of both FIG. 2B and FIG. 3B can also take place simultaneously such that the N-containing salt, such as the N-containing inorganic salt or the N-containing organic salt and optionally ammonia may be partially present in the aqueous solution and partially present in the gaseous stream.

In some embodiments of the aspects and embodiments provided herein, the gaseous stream comprising ammonia may have ammonia from an external source and/or is recovered and recirculated from step A of the process.

In some embodiments of the aspects and embodiments provided herein, wherein the gaseous stream comprises ammonia and/or the gaseous stream comprises carbon dioxide, no external source of carbon dioxide and/or ammonia is used, and the process is a closed loop process. Such closed loop process is being illustrated in the figures described herein.

In some embodiments, the dissolution of the lime or the limestone with some of the N-containing organic salt may not result in the formation of ammonia gas or the amount of ammonia gas formed may not be substantial. In embodiments where the ammonia gas is not formed or is not formed in substantial amounts, the methods and systems illustrated in FIGS. 2A and 2B where the aqueous solution comprising calcium salt is treated with the carbon dioxide gas, are applicable. In such embodiments, the organic amine salt may remain in the aqueous solution in fully or partially dissolved state or may separate as an organic amine layer, as shown in the reaction below:

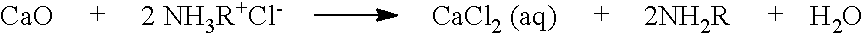

The N-containing organic salt or the N-containing organic compound remaining in supernatant solution after the precipitation may be called residual N-containing organic salt or residual N-containing organic compound. Methods and systems have been described herein to recover the residual compounds from the precipitate as well as the supernatant solution.

In one aspect, the ammonia gas and the CO₂ gas may be recovered and cooled down in a cooling reactor before mixing the cooled solution with the aqueous solution comprising calcium salt. This aspect is illustrated in FIGS. 4A and 4B.

In one aspect, there are provided methods to form the composition by (i) calcining the limestone to form the lime and the gaseous stream comprising carbon dioxide; (ii) dissolving the lime in the aqueous N-containing inorganic salt solution or N-containing organic salt solution to produce the first aqueous solution comprising calcium salt, and the gaseous stream comprising ammonia; (iii) recovering the gaseous stream comprising carbon dioxide and the gaseous stream comprising ammonia and subjecting the gaseous streams to a cooling process to condense a second aqueous solution comprising ammonium bicarbonate, ammonium carbonate, ammonia, ammonium carbamate, or combination thereof; (iv) treating the first aqueous solution comprising calcium salt with the second aqueous solution comprising ammonium bicarbonate, ammonium carbonate, ammonia, ammonium carbamate, or combination thereof to form the composition comprising vaterite particles; (v) blending the composition comprising vaterite particles with the GCC particles to form the blend comprising the vaterite particles and the GCC particles; and (vi) forming the calcium carbonate blend composition comprising the blend. In some embodiments of the above noted aspect, the blend comprises the vaterite particles having an average particle size of between about 0.1-50 μm and the GCC particles having an average particle size of between about 1-150 μm.

Ammonium carbamate has a formula NH₄[H₂NCO₂] consisting of ammonium ions NH₄⁺, and carbamate ions H₂NCO₂⁻.

This aspect is illustrated in FIG. 4A, wherein the gaseous stream comprising CO₂ from the calcination step and the gaseous stream comprising NH₃ from step A of the process is recirculated to the cooling reactor/reaction (step F) for the formation of the carbonate and bicarbonate solutions as shown in the reactions further herein below. Remaining steps of FIG. 4A are identical to the steps of FIGS. 2A and 3A.

It is to be understood that the aforementioned aspect illustrated in FIG. 4A may be combined with the aspects illustrated in FIG. 2A and/or FIG. 3A such that the precipitation step C comprises treating the first aqueous solution comprising calcium salt with the second aqueous solution comprising ammonium bicarbonate, ammonium carbonate, ammonia, ammonium carbamate, or combinations thereof (illustrated in FIG. 4A), as well as comprises treating the aqueous solution comprising calcium salt with the gaseous stream comprising carbon dioxide (illustrated in FIG. 2A) and/or comprises treating the aqueous solution comprising calcium salt with the gaseous stream comprising carbon dioxide and the gaseous stream comprising ammonia (illustrated in FIG. 3A). In such embodiments, the gaseous stream comprising carbon dioxide is split between the stream going to the cooling process and the stream going to the precipitation process. Similarly, in such embodiments, the gaseous stream comprising ammonia is split between the stream going to the cooling process and the stream going to the precipitation process. Any combination of the processes depicted in FIGS. 2A, 3A, and 4A is possible and all are within the scope of this disclosure.

In one aspect, there are provided methods to form the composition by (i) dissolving the limestone in the aqueous N-containing inorganic salt solution or N-containing organic salt solution to produce the first aqueous solution comprising calcium salt, the gaseous stream comprising carbon dioxide and the gaseous stream comprising ammonia; (ii) recovering the gaseous stream comprising carbon dioxide and the gaseous stream comprising ammonia and subjecting the gaseous streams to a cooling process to condense a second aqueous solution comprising ammonium bicarbonate, ammonium carbonate, ammonia, ammonium carbamate, or combinations thereof, (iii) treating the first aqueous solution comprising calcium salt with the second aqueous solution comprising ammonium bicarbonate, ammonium carbonate, ammonia, ammonium carbamate, or combinations thereof to form the composition comprising vaterite particles; (iv) blending the composition comprising vaterite particles with the GCC particles to form the blend comprising the vaterite particles and the GCC particles; and (v) forming the calcium carbonate blend composition comprising the blend. In some embodiments of the above noted aspect, the blend comprises the vaterite particles having an average particle size of between about 0.1-50 μm and the GCC particles having an average particle size of between about 1-150 μm.

This aspect is illustrated in FIG. 4B, wherein the gaseous stream comprising CO₂ and the gaseous stream comprising NH₃ from step A of the process are recirculated to the cooling reactor/reaction (step F) for the formation of the carbonate and bicarbonate solutions as shown in the reactions further herein below. Remaining steps of FIG. 4B are identical to the steps of FIGS. 2B and 3B.

It is to be understood that the aforementioned aspect illustrated in FIG. 4B may be combined with the aspects illustrated in FIG. 2B and/or FIG. 3B such that the precipitation step C comprises treating the first aqueous solution comprising calcium salt with the second aqueous solution comprising ammonium bicarbonate, ammonium carbonate, ammonia, ammonium carbamate, or combinations thereof (illustrated in FIG. 4B), as well as comprises treating the aqueous solution comprising calcium salt with the gaseous stream comprising carbon dioxide (illustrated in FIG. 2B) and/or comprises treating the aqueous solution comprising calcium salt with the gaseous stream comprising carbon dioxide and the gaseous stream comprising ammonia (illustrated in FIG. 3B). In such embodiments, the gaseous stream comprising carbon dioxide is split between the stream going to the cooling process and the stream going to the precipitation process. Similarly, in such embodiments, the gaseous stream comprising ammonia is split between the stream going to the cooling process and the stream going to the precipitation process. Any combination of the processes depicted in FIGS. 2B, 3B, and 4B is possible and all are within the scope of this disclosure.

The combination of these condensed products in the second aqueous solution may be dependent on the one or more of the cooling conditions.

In some embodiments of the aforementioned aspect and embodiments, the gaseous stream (e.g., the gaseous streams going to the cooling reaction/reactor (step F in FIGS. 4A and 4B)) further comprises water vapor. In some embodiments, the water vapor is present in the gaseous stream comprising carbon dioxide and/or is present in the gaseous stream comprising ammonia. In some embodiments of the aforementioned aspect and embodiments, the gaseous stream further comprises between about 20-90%; or between about 20-80%; or between about 20-70%; or between about 20-60%; or between about 20-55%; or between about 20-50%; or between about 20-40%; or between about 20-30%; or between about 20-25%; or between about 30-90%; or between about 30-80%; or between about 30-70%; or between about 30-60%; or between about 30-50%; or between about 30-40%; or between about 40-90%; or between about 40-80%; or between about 40-70%; or between about 40-60%; or between about 40-50%; or between about 50-90%; or between about 50-80%; or between about 50-70%; or between about 50-60%; or between about 60-90%; or between about 60-80%; or between about 60-70%; or between about 70-90%; or between about 70-80%; or between about 80-90%, water vapor.

Intermediate steps in the cooling reaction/reactor may include the formation of ammonium carbonate and/or ammonium bicarbonate and/or ammonium carbamate, by reactions as below:

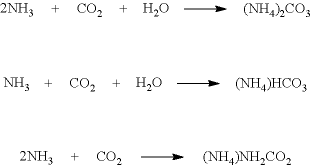

Similar reactions may be shown for the N-containing organic salt:

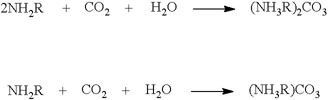

An advantage of cooling the ammonia in the cooling reaction/reactor is that ammonia may have a limited vapor pressure in the vapor phase of the dissolution reaction. By reacting the ammonia with CO₂, as shown in the reactions above, can remove some ammonia from the vapor space, allowing more ammonia to leave the dissolution solution.

The second aqueous solution comprising ammonium bicarbonate, ammonium carbonate, ammonia carbamate, ammonia, or combination thereof (exiting the cooling reaction/reactor in FIGS. 4A and 4B) is then treated with the first aqueous solution comprising calcium salt from the dissolution reaction/reactor, in the precipitation reaction/reactor (step C) to form the precipitation material or the composition comprising vaterite:

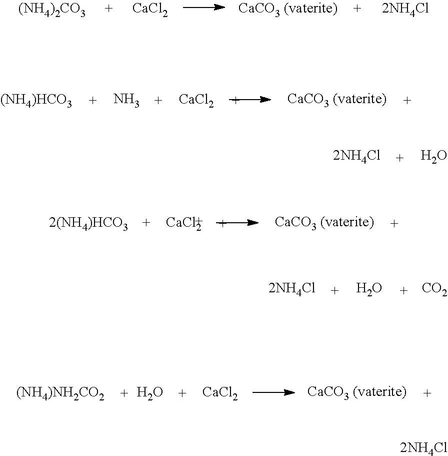

In some embodiments of the aspects and embodiments provided herein, the one or more cooling conditions comprise temperature between about 0-200° C., or between about 0-150° C., or between about 0-75° C., or between about 0-100° C., or between about 0-80° C., or between about 0-60° C., or between about 0-50° C., or between about 0-40° C., or between about 0-30° C., or between about 0-20° C., or between about 0-10° C.

In some embodiments of the aspects and embodiments provided herein, the one or more cooling conditions comprise pressure between about 0.5-50 atm; or between about 0.5-25 atm; or between about 0.5-10 atm; or between about 0.1-10 atm; or between about 0.5-1.5 atm; or between about 0.3-3 atm.

In some embodiments, the formation, the particle size or its distribution, and the quality of the vaterite particles formed in the methods and systems provided herein, is dependent on the amount and/or the ratio of the condensed products in the second aqueous solution comprising ammonium bicarbonate, ammonium carbonate, ammonia, ammonium carbamate, or combinations thereof.

In some embodiments, the presence or absence or distribution of the condensed products in the second aqueous solution comprising ammonium bicarbonate, ammonium carbonate, ammonia, ammonium carbamate, or combinations thereof, can be optimized in order to maximize the formation of the vaterite and/or to obtain a desired particle size distribution. This optimization can be based on the one or more cooling conditions, such as, pH of the aqueous solution in the cooling reactor, flow rate of the CO₂ and the NH₃ gases, and/or ratio of the CO₂:NH₃ gases. The inlets for the cooling reactor may be carbon dioxide (CO_{2(g)}), the dissolution reactor gas exhaust containing ammonia (NH_{3(g)}), water vapor, and optionally fresh makeup water (or some other dilute water stream). The outlet may be a slipstream of the reactor's recirculating fluid (the second aqueous solution), which is directed to the precipitation reactor for contacting with the aqueous solution and optionally additional carbon dioxide and/or ammonia. The pH of the system may be controlled by regulating the flow rate of CO₂ and NH₃ into the cooling reactor. The conductivity of the system may be controlled by addition of dilute makeup water to the cooling reactor. Volume may be maintained constant by using a level detector in the cooling reactor or it's reservoir.

It is to be understood that while FIGS. 4A and 4B illustrate a separate cooling reaction/reactor, in some embodiments, the dissolution reaction/reactor may be integrated with the cooling reaction/reactor. For example, the dissolution reactor may be integrated with a condenser acting as a cooling reactor. Various configurations of the integrated reactor described above, are described in U.S. application Ser. No. 17/184,933, filed Feb. 25, 2021, which is incorporated herein by reference in its entirety.

In the aforementioned aspects, both the dissolution and the cooling reactors are fitted with inlets and outlets to receive the required gases and collect the aqueous streams. In some embodiments of the aforementioned aspect, the dissolution reactor comprises a stirrer to mix the lime or the limestone with the aqueous N-containing salt solution. The stirrer can also facilitate upward movement of the gases. In some embodiments of the aforementioned aspect, the dissolution reactor is configured to collect the solid settled at the bottom of the reactor after removing the first aqueous solution comprising calcium salt. In some embodiments of the aforementioned aspect, the cooling tower comprises one or more trays configured to catch and collect the condensed second aqueous solution and prevent it from falling back into the dissolution reactor. As such, the cooling/condensation may be accomplished through use of infusers, bubblers, fluidic Venturi reactors, spargers, gas filters, sprays, trays, or packed column reactors, and the like.

In some embodiments, the contacting of the aqueous solution comprising calcium salt with the carbon dioxide and optionally ammonia or second aqueous solution is achieved by contacting the aqueous solution to achieve and maintain a desired pH range, a desired temperature range, and/or desired divalent cation concentration using a convenient protocol as described herein (precipitation conditions). In some embodiments, the systems include a precipitation reactor configured to contact the aqueous solution comprising calcium salt with carbon dioxide and optionally ammonia from step A of the process or the systems include a precipitation reactor configured to contact the first aqueous solution comprising calcium salt with the second aqueous solution comprising ammonium bicarbonate, ammonium carbonate, ammonia, ammonium carbamate, or combinations thereof.

In some embodiments, the aqueous solution comprising calcium salt may be placed in a precipitation reactor, wherein the amount of the aqueous solution comprising calcium salt added is sufficient to raise the pH to a desired level (e.g., a pH that induces precipitation of the precipitation material) such as pH 7-9, pH 7-8.7, pH 7-8.5, pH 7-8, pH 7.5-8, pH 8-8.5, pH 8.5-9, pH 9-14, pH 10-14, pH 11-14, pH 12-14, or pH 13-14. In some embodiments, the pH of the aqueous solution comprising calcium salt when contacted with the carbon dioxide and optionally the NH₃ or the second aqueous solution, is maintained at between 7-9 or between 7-8.7 or between 7-8.5 or between 7.5-8.5 or between 7-8, or between 7.6-8.5, or between 8-8.5, or between 7.5-9.5 in order to form the vaterite particles.

The aqueous solution comprising calcium salt may be contacted with the gaseous stream comprising the CO₂ and optionally the NH₃ using any convenient protocol. The contact protocols of interest include, but not limited to, direct contacting protocols (e.g., bubbling the gases through the aqueous solution), concurrent contacting means (i.e., contact between unidirectional flowing gaseous and liquid phase streams), countercurrent means (i.e., contact between oppositely flowing gaseous and liquid phase streams), and the like. As such, contact may be accomplished through use of infusers, bubblers, fluidic Venturi reactors, spargers, gas filters, sprays, trays, or packed column reactors, and the like, in the precipitation reactor. In some embodiments, gas-liquid contact is accomplished by forming a liquid sheet of solution with a flat jet nozzle, wherein the gases and the liquid sheet move in countercurrent, co-current, or crosscurrent directions, or in any other suitable manner. In some embodiments, gas-liquid contact is accomplished by contacting liquid droplets of the solution having an average diameter of 500 micrometers or less, such as 100 micrometers or less, with the gas source.

Any number of the gas-liquid contacting protocols described herein may be utilized. Gas-liquid contact or the liquid-liquid contact is continued until the pH of the precipitation reaction mixture is optimum (various optimum pH values have been described herein to form the precipitation material or the composition comprising e.g., vaterite particles), after which the precipitation reaction mixture is allowed to stir. The rate at which the pH drops may be controlled by addition of more of the aqueous solution comprising calcium salt during gas-liquid contact or the liquid-liquid contact. In addition, additional aqueous solution may be added after sparging to raise the pH back to basic levels for precipitation of a portion or all the precipitation material. In any case, the precipitation material may be formed upon removing protons from certain species in the precipitation reaction mixture. The precipitation material comprising carbonates may then be separated and optionally, further processed.

The one or more precipitation conditions include those that modulate the environment of the precipitation reaction mixture to produce the desired precipitation material or the composition comprising vaterite particles. Such one or more precipitation conditions include, but not limited to, temperature, pH, pressure, ion ratio, precipitation rate, presence of additive, presence of ionic species, concentration of additive and ionic species, stirring, residence time, mixing rate, forms of agitation such as ultrasonics, presence of seed crystals, catalysts, membranes, or substrates, dewatering, drying, ball milling, etc. In some embodiments, the average particle size of the vaterite may also depend on the one or more precipitation conditions used in the precipitation of the precipitation material.

For example, the temperature of the precipitation reaction may be raised to a point at which an amount suitable for precipitation of the desired precipitation material occurs. In such embodiments, the temperature of the precipitation reaction may be raised to a value, such as from 20° C. to 60° C., and including from 25° C. to 60° C.; or from 30° C. to 60° C.; or from 35° C. to 60° C.; or from 40° C. to 60° C.; or from 50° C. to 60° C.; or from 25° C. to 50° C.; or from 30° C. to 50° C.; or from 35° C. to 50° C.; or from 40° C. to 50° C.; or from 25° C. to 40° C.; or from 30° C. to 40° C.; or from 25° C. to 30° C. In some embodiments, the temperature of the precipitation reaction may be raised using energy generated from low or zero carbon dioxide emission sources (e.g., solar energy source, wind energy source, hydroelectric energy source, waste heat from the flue gases of the carbon emitter, etc.).

The pH of the precipitation reaction may also be raised to an amount suitable for the precipitation of the desired precipitation material. In such embodiments, the pH of the precipitation reaction may be raised to alkaline levels for precipitation. In some embodiments, the precipitation conditions required to form the precipitation material include pH higher than 7 or pH of 8 or pH of between 7.1-8.5 or pH of between 7.5-8 or between 7.5-8.5 or between 8-8.5 or between 8-9 or between 7.6-8.4, in order to form the precipitation material. The pH may be raised to pH 9 or higher, such as pH 10 or higher, including pH 11 or higher or pH 12.5 or higher.

Adjusting major ion ratios during precipitation may influence the nature of the precipitation material. Major ion ratios may have considerable influence on polymorph formation. For example, as the magnesium:calcium ratio in the water increases, the aragonite may become the major polymorph of calcium carbonate in the precipitation material over low-magnesium vaterite. At low magnesium:calcium ratios, low-magnesium calcite may become the major polymorph. In some embodiments, where Ca²⁺ and Mg²⁺ are both present, the ratio of Ca²⁺ to Mg²⁺ (i.e., Ca²⁺:Mg²⁺) in the precipitation material is 1:1 to 1:2.5; 1:2.5 to 1:5; 1:5 to 1:10; 1:10 to 1:25; 1:25 to 1:50; 1:50 to 1:100; 1:100 to 1:150; 1:150 to 1:200; 1:200 to 1:250; 1:250 to 1:500; or 1:500 to 1:1000. In some embodiments, the ratio of Mg²⁺ to Ca²⁺ (i.e., Mg²⁺:Ca²⁺) in the precipitation material is 1:1 to 1:2.5; 1:2.5 to 1:5; 1:5 to 1:10; 1:10 to 1:25; 1:25 to 1:50; 1:50 to 1:100; 1:100 to 1:150; 1:150 to 1:200; 1:200 to 1:250; 1:250 to 1:500; or 1:500 to 1:1000.

In some embodiments, the one or more precipitation conditions to produce the desired precipitation material from the precipitation reaction may include, as above, the temperature and pH, as well as, in some instances, the concentrations of additives and ionic species in the water. The additives have been described herein below. The presence of the additives and the concentration of the additives may also favor formation of stable or reactive vaterite. In some embodiments, a middle chain or long chain fatty acid ester may be added to the aqueous solution during the precipitation to form the composition comprising vaterite. Examples of fatty acid esters include, without limitation, cellulose such as carboxymethyl cellulose, sorbitol, citrate such as sodium or potassium citrate, stearate such as sodium or potassium stearate, phosphate such as sodium or potassium phosphate, sodium tripolyphosphate, hexametaphosphate, EDTA, or combinations thereof. In some embodiments, a combination of stearate and citrate may be added during the precipitation step of the process.

In some embodiments, the gas leaving the precipitation reactor (shown as “scrubbed gas” in the figures) passes to a gas treatment unit for a scrubbing process. The mass balance and equipment design for the gas treatment unit may depend on the properties of the gases. In some embodiments, the gas treatment unit may incorporate an HCl scrubber for recovering the small amounts of NH₃ in the gas exhaust stream that may be carried from the CO₂ absorption, precipitation step by the gas. NH₃ may be captured by the HCl solution through:

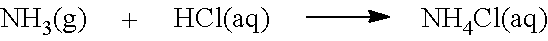

The NH₄Cl (aq) from the HCl scrubber may be recycled to the dissolution step A.

In some embodiments, the gas exhaust stream comprising ammonia (shown as “scrubbed gas” in the figures) may be subjected to a scrubbing process where the gas exhaust stream comprising ammonia is scrubbed with the carbon dioxide from the industrial process and water to produce a solution of ammonia. The inlets for the scrubber may be carbon dioxide (CO_{2(g)}), the reactor gas exhaust containing ammonia (NH_{3(g)}), and fresh makeup water (or some other dilute water stream). The outlet may be a slipstream of the scrubber's recirculating fluid (e.g. H₃N—CO_{2(aq)} or carbamate), which may optionally be returned back to the main reactor for contacting with carbon dioxide and precipitation. The pH of the system may be controlled by regulating the flow rate of CO_{2(g)} into the scrubber.

In some embodiments, the methods and systems provided herein further include separating the precipitation material or the precipitate of the vaterite particles (step D in FIGS. 2A, 2B, 3A, 3B, 4A, and 4B) from the aqueous solution by dewatering to form a cake or wet form or slurry form of the composition comprising vaterite particles. In some embodiments, the cake form of the composition comprising vaterite particles with desired particle size(s) and distribution may then be blended with the GCC particles to form the blend. The blend may then be optionally mixed with other components to form the calcium carbonate blend composition (shown as CCBC in FIGS. 1, 2A, 2B, 3A, 3B, 4A, and 4B). The calcium carbonate blend composition can be used to make cement product and/or non-cement product.

In some embodiments, the cake of the composition comprising vaterite particles may be subjected optionally to rinsing, and optionally drying (step E in FIGS. 2A, 2B, 3A, 3B, 4A, and 4B). The dried form or the dry powder form of the composition comprising vaterite particles with desired particle size(s) and distribution may then be blended with the GCC particles to form the blend comprising the vaterite particles and the GCC particles. The blend may then be optionally mixed with other components to form the calcium carbonate blend composition (shown as CCBC in FIGS. 1, 2A, 2B, 3A, 3B, 4A, and 4B). The calcium carbonate blend composition can be used to make cement product and/or non-cement product.

The methods and systems provided herein may result in residual N-containing salt such as the residual N-containing inorganic or N-containing organic salt, e.g., residual ammonium salt remaining in the supernatant solution as well as in the precipitate itself after the formation of the precipitate. The residual base such as the N-containing inorganic or N-containing organic salt, e.g., residual ammonium salt (e.g., residual NH₄Cl) as used herein includes any salt that may be formed by ammonium ions and anions present in the solution including, but not limited to halogen ions such as chloride ions, acetate ions, nitrate or nitrite ions, and sulfur ions such as, sulfate ions, sulfite ions, thiosulfate ions, hydrosulfide ions, and the like. In some embodiments, the residual N-containing inorganic salt comprises ammonium halide, ammonium acetate, ammonium sulfate, ammonium sulfite, ammonium hydrosulfide, ammonium thiosulfate, ammonium nitrate, ammonium nitrite, or combinations thereof. These residual salts may be removed and optionally recovered from the supernatant solution as well as the precipitate. In some embodiments, the supernatant solution further comprising the N-containing inorganic or N-containing organic salt, e.g., residual ammonium salt (e.g., residual NH₄Cl), is recycled back to the dissolution reactor for the dissolution of the lime or the limestone (to step A in FIGS. 2A, 2B, 3A, 3B, 4A, and 4B).

The cake form of the composition comprising vaterite particles may be sent to the dryer (step E in FIGS. 2A, 2B, 3A, 3B, 4A, and 4B) to form dry powder composition comprising vaterite particles with desired particle size (e.g., the average particle size of between about 0.1-50 μm). The powder form of the vaterite particles is then blended with the GCC particles to form the blend which is optionally mixed with the other components to form the CCBC, used further to form the cement products, as described herein. The cake may be dried using any drying techniques known in the art such as, but not limited to fluid bed dryer or swirl fluidizer. The resulting solid powder of the composition comprising vaterite particles after blending with the GCC particles, may be then mixed with the other components such as, aluminosilicate material, SCM, e.g., limestone, Portland cement clinker, admixtures, accelerators, additives, or mixtures thereof to make different types of the CCBC described herein. In some embodiments, the slurry form with reduced water or the cake form of the composition comprising vaterite particles is directly used to form the cement products, as described herein.

Depending on the particular drying protocol of the system, the drying station may include a filtration element, freeze-drying structure, spray-drying structure, etc. In some embodiments, the precipitate may be dried by fluid bed dryer. In certain embodiments, waste heat from a power plant or similar operation may be used to perform the drying step when appropriate.

The CCBC (optionally including solid from step B as described herein) undergoes curing and transformation to the interlocking acicular shaped aragonite (optionally containing one or more voids forming a honeycomb structure) or calcite or carboaluminate (when combined with Portland cement or aluminosilicate material) and sets and hardens into the cement product.

In the systems provided herein, the separation or dewatering step D may be carried out on the separation station. The cake or the precipitate comprising vaterite particles may be stored in the supernatant for a period of time following precipitation and prior to separation. For example, the precipitate may be stored in the supernatant for a period of time ranging from few min to hours to 1 to 1000 days or longer, such as 1 to 10 days or longer, at a temperature ranging from 1° C. to 40° C., such as 20° C. to 25° C. Separation or dewatering may be achieved using any of a number of convenient approaches, including draining (e.g., gravitational sedimentation of the precipitate comprising vaterite particles followed by draining), decanting, filtering (e.g., gravity filtration, vacuum filtration, filtration using forced air), centrifuging, pressing, or any combination thereof. Separation of the bulk water from the precipitate or the composition comprising vaterite particles produces a wet cake of the composition, or a dewatered composition comprising vaterite particles. Liquid-solid separator such as Epuramat's Extrem-Separator (“ExSep”) liquid-solid separator, Xerox PARC's spiral concentrator, or a modification of either of Epuramat's ExSep or Xerox PARC's spiral concentrator, may be useful for the separation of the composition comprising vaterite particles.

In some embodiments, the comprising reactive vaterite particles may be activated such that the reactive vaterite leads to the interlocking acicular shaped aragonitic pathway and not calcite pathway during dissolution-re-precipitation process. In some embodiments, the reactive vaterite particles composition is activated in such a way that after the dissolution-re-precipitation process, the interlocking acicular shaped aragonite formation is enhanced, and the calcite formation is suppressed. The activation of the reactive vaterite composition may result in control over the interlocking acicular shaped aragonite formation and crystal growth. Various examples of the activation of the comprising reactive vaterite particles, such as, but not limited to, nuclei activation, thermal activation, mechanical activation, chemical activation, or combination thereof, are described herein. In some embodiments, the reactive vaterite is activated through various processes such that the interlocking acicular shaped aragonite optionally containing the calcite in minor amount and its morphology and/or crystal growth can be controlled upon reaction of the reactive vaterite particles composition with water. The interlocking acicular shaped aragonite with optional calcite formed results in higher tensile strength and fracture tolerance to the cement product formed from the reactive vaterite.

In some embodiments, the reactive vaterite may be activated by mechanical means, as described herein. For example, the reactive vaterite particles composition may be activated by creating surface defects on the vaterite composition such that the interlocking acicular shaped aragonite formation is accelerated. In some embodiments, the activated vaterite is a ball-milled reactive vaterite or is a reactive vaterite with surface defects such that the interlocking acicular shaped aragonite formation pathway is facilitated.

The composition comprising reactive vaterite particles may also be activated by providing chemical or nuclei activation to the vaterite composition. Such chemical or nuclei activation may be provided by one or more of aragonite seeds, inorganic additive, or organic additive. The aragonite seed present in the compositions provided herein may be obtained from natural or synthetic sources. The natural sources include, but not limited to, reef sand, lime, hard skeletal material of certain fresh-water and marine invertebrate organisms, including pelecypods, gastropods, mollusk shell, and calcareous endoskeleton of warm- and cold-water corals, pearls, rocks, sediments, ore minerals (e.g., serpentine), and the like. The synthetic sources include, but not limited to, precipitated aragonite, such as formed from sodium carbonate and calcium chloride; or the interlocking acicular shaped aragonite formed by the transformation of the reactive vaterite to the aragonite, such as transformed reactive vaterite described herein.

In some embodiments, the composition comprising reactive vaterite particles, the blend comprising the vaterite particles and the GCC particles, and/or the calcium carbonate blend composition comprising the blend (and optionally the other components), further comprises inorganic additive and/or organic additive. In some embodiments, the inorganic additive or the organic additive in the compositions provided herein can be any additive that activates reactive vaterite.

Some examples of the inorganic additive or the organic additive in the compositions provided herein, include, but not limited to, sodium decyl sulfate, lauric acid, sodium salt of lauric acid, urea, citric acid, sodium salt of citric acid, phthalic acid, sodium salt of phthalic acid, taurine, creatine, dextrose, poly(n-vinyl-1-pyrrolidone), aspartic acid, sodium salt of aspartic acid, magnesium chloride, acetic acid, sodium salt of acetic acid, glutamic acid, sodium salt of glutamic acid, strontium chloride, gypsum, lithium chloride, sodium chloride, glycine, sodium citrate dehydrate, sodium bicarbonate, magnesium sulfate, magnesium acetate, sodium polystyrene, sodium dodecylsulfonate, poly-vinyl alcohol, or combination thereof. In some embodiments, the inorganic additive or the organic additive in the compositions provided herein, include, but not limited to, taurine, creatine, poly(n-vinyl-1-pyrrolidone), lauric acid, sodium salt of lauric acid, urea, magnesium chloride, acetic acid, sodium salt of acetic acid, strontium chloride, magnesium sulfate, magnesium acetate, or combination thereof. In some embodiments, the inorganic additive or the organic additive in the compositions provided herein, include, but not limited to, magnesium chloride, magnesium sulfate, magnesium acetate, or combination thereof.

During the mixing of the blend itself or optionally with the other components as mentioned herein or mixing with the aqueous medium to form the wet composition, the composition may be subjected to high shear mixer (in the mixer system). The components can be blended using any suitable protocol. Each material may be mixed at the time of work, or part of or all of the materials may be mixed in advance. As a mixing apparatus, any conventional apparatus can be used. For example, Hobart mixer, pin mixer, slant cylinder mixer, Omni Mixer, Henschel mixer, V-type mixer, and Nauta mixer can be employed.

The methods and systems provided herein further comprise a control system configured to remotely and/or automatedly control the calcining reactor, the dissolution reactor, the treatment reactor, the blending station, and/or the mixer system.

The methods and systems may also include one or more detectors configured for monitoring the systems producing the blends and the compositions and the systems producing the cement products. Monitoring may include, but is not limited to, collecting data about the pressure, temperature, humidity, and composition. The detectors may be any convenient device configured to monitor, for example, pressure sensors (e.g., electromagnetic pressure sensors, potentiometric pressure sensors, etc.), temperature sensors (resistance temperature detectors, thermocouples, gas thermometers, thermistors, pyrometers, infrared radiation sensors, etc.), volume sensors (e.g., geophysical diffraction tomography, X-ray tomography, hydroacoustic surveyers, etc.), and devices for determining chemical makeup of the composition (e.g, IR spectrometer, NMR spectrometer, UV-vis spectrophotometer, high performance liquid chromatographs, inductively coupled plasma emission spectrometers, inductively coupled plasma mass spectrometers, ion chromatographs, X-ray diffractometers, gas chromatographs, gas chromatography-mass spectrometers, flow-injection analysis, scintillation counters, acidimetric titration, and flame emission spectrometers, etc.).

In some embodiments, detectors may also include a computer interface which is configured to provide a user with the collected data about the composition. In some embodiments, the summary may be stored as a computer readable data file or may be printed out as a user readable document.

In some embodiments, the detector may be a monitoring device such that it can collect real-time data (e.g., internal pressure, temperature, etc.). In other embodiments, the detector may be one or more detectors configured to determine the parameters at regular intervals, e.g., determining the composition every 1 minute, every 5 minutes, every 10 minutes, every 30 minutes, every 60 minutes, every 100 minutes, every 200 minutes, every 500 minutes, or some other interval.

A control station may include a set of valves or multi-valve systems which are manually, mechanically, or digitally controlled, or may employ any other convenient flow regulator protocol. In some instances, the control station may include a computer interface, (where regulation is computer-assisted or is entirely controlled by computer) configured to provide a user with input and output parameters to control the production of the cement products, as described above.

### III. Cement Products and Non-Cement Products

In one aspect, there are provided cement products formed from the calcium carbonate blend compositions provided herein. The “cement product” or the “cementitious product” are used interchangeably herein and include any cement product formed from the calcium carbonate blend compositions provided herein. Various examples of the cement product have been provided herein.

In one aspect, there are provided non-cement products formed from the calcium carbonate blend compositions provided herein. The “non-cement product” or the “non-cementitious product” are used interchangeably herein and include any non-cement product formed from the calcium carbonate blend compositions provided herein. Various examples of the non-cement product have been provided herein.

The cementitious product or the non-cementitious product may be formed from the calcium carbonate blend composition comprising blend comprising vaterite particles and limestone particles where the vaterite particles may be stable vaterite particles or the reactive vaterite particles. In some embodiments, the calcium carbonate blend composition comprising blend comprising vaterite particles and limestone particles optionally with other components, when mixed with water may or may not result in the transformation of the vaterite particles. For example, the stable vaterite particles may stay as is and the reactive vaterite particles may transform upon dissolution reprecipitation to form aragonite, calcite, or combination thereof. In some embodiments, when the other component is the aluminosilicate material, the dissolution re-precipitation in water may result in the formation of the carboaluminate (as described herein). In some embodiments, the aragonite, calcite, or combination thereof may set and harden to form cement products. In some embodiments, the aragonite may be formed as an interlocking acicular shaped microstructure.

In some embodiments, the cement product comprises an interlocking acicular shaped aragonite microstructure, calcite, carboaluminate, or combinations thereof. In some embodiments, when the reactive vaterite in the calcium carbonate blend composition transforms to aragonite, the interlocking acicular shaped aragonite surrounds one or more voids. In some embodiments, the interlocking acicular shaped aragonite surrounding one or more voids forms a honeycomb structure. In some embodiments, when the reactive vaterite in the calcium carbonate blend composition transforms to calcite, the calcite matrix surrounds one or more voids. In some embodiments, the calcite matrix surrounding one or more voids forms a honeycomb structure. In some embodiments, the cement products are lightweight cement products with low packing density or low bulk density.

In some embodiments, the cement product formed from the compositions provided herein, is a building material. The “building material” used herein includes material used in construction. Examples of such structures or the building materials include, but are not limited to, building, driveway, foundation, kitchen slab, furniture, pavement, road, bridges, motorway, overpass, parking structure, brick, block, wall, footing for a gate, fence, pole, and/or module thereof.

In some embodiments, the cement product formed from the compositions provided herein, is an aggregate, such as e.g., lightweight aggregate.

In some embodiments, the cement product provided herein comprising interlocking acicular shaped aragonite has up to about 99.9% aragonite, or up to 99% aragonite, or up to 97% aragonite, or up to 95% aragonite, or up to 90% aragonite, or up to 80% aragonite, or between about 80-99.9% aragonite, or between about 80-99% aragonite, or between about 80-95% aragonite. In some embodiments, the cement product provided herein comprising calcite has up to about 99.9% calcite, or up to 99% calcite, or up to 97% calcite, or up to 95% calcite, or up to 90% calcite, or up to 80% calcite, or between about 80-99.9% calcite, or between about 80-99% calcite, or between about 80-95% calcite. In some embodiments, the remaining amount in the cement products is limestone and/or other components.

In some embodiments, the cement product provided herein comprising interlocking acicular shaped aragonite and/or calcite matrix, have porosity of between about 10-90%. In some embodiments, depending on the average particle size of the vaterite particles and the limestone particles in the blend; the porosity of the cement product may be controlled to be between 10%-90%. Porosity may be beneficial for making lightweight cement product that may be useful for building applications, thermal insulating, filtration applications, and the like. In some embodiments, a highly porous cement product comprising the interlocking acicular shaped aragonite and/or calcite may be desired, in others a cement product of moderate porosity may be desired, while in other cases cement products of low porosity, or no porosity, may be desired. The aforementioned porous cement product may be lightweight cement product. Porosities of the cement products may be measured, e.g., by water uptake after oven drying followed by fully saturating the cement product by water immersion, expressed as % dry weight (measured relative to the dry weight), can be in the range of about 10-90%; or between about 10-80%; or between about 10-70%; or between about 10-60%; or between about 10-50%; or between about 10-40%; or between about 10-30%; or between about 10-20%; or between about 20-90%; or between about 20-80%; or between about 20-70%; or between about 20-60%; or between about 20-50%; or between about 20-40%; or between about 20-30%; or between about 30-90%; or between about 30-80%; or between about 30-70%; or between about 30-60%; or between about 30-50%; or between about 30-40%; or between about 40-90%; or between about 40-80%; or between about 40-70%; or between about 40-60%; or between about 40-50%; or between about 50-90%; or between about 50-80%; or between about 50-70%; or between about 50-60%; or between about 60-80%; or between about 70-80%; or between about 1-40%, such as 2-20%, or 2-15%, including 2-10% or even 3-9%.

In some embodiments, the aggregate provided herein comprising interlocking acicular shaped aragonite and/or calcite, may provide for mortar as fine aggregate and/or concrete as coarse aggregate. The fine aggregate may be material that almost entirely pass through a Number 4 sieve (ASTM C 125 and ASTM C 33) and the coarse aggregate may be material that is predominantly retained on a Number 4 sieve (ASTM C 125 and ASTM C 33).

In some embodiments, the cement product ranges in bulk density (unit weight) from 25-200 lb/ft³ (pound/cubic feet), or from 25-110 lb/ft³, or from 25-75 lb/ft³, or from 25-50 lb/ft³, or from 50-200 lb/ft³, or from 50-100 lb/ft³, or from 50-75 lb/ft³, or from 75-175 lb/ft³, or from 25-55 lb/ft³, or from 75-125 lb/ft³, or from 90-115 lb/ft³, or from 100-200 lb/ft³, or from 125-175 lb/ft³, or from 140-160 lb/ft³. Some embodiments include lightweight cement product, e.g., aggregate that has the bulk density (unit weight) of 25 lb/ft³ to 75 lb/ft³. Some embodiments include lightweight aggregate, e.g., aggregate that has the bulk density (unit weight) of 25 lb/ft³ to 55 lb/ft³.

In some embodiments of the foregoing aspects and the foregoing embodiments, the cement product provided herein comprising interlocking acicular shaped aragonite and/or calcite has a compressive strength of between about 250-5000 psi; or between about 250-4000 psi; or between about 250-3000 psi; or between about 250-2000 psi; or between about 250-1000 psi; or between about 250-500 psi; or between about 500-5000 psi; or between about 500-4000 psi; or between about 500-3000 psi; or between about 500-2000 psi; or between about 500-1000 psi; or between about 1000-5000 psi; or between about 1000-4000 psi; or between about 1000-3000 psi; or between about 1000-2000 psi; or between about 2000-5000 psi; or between about 2000-4000 psi; or between about 2000-3000 psi; or between about 3000-5000 psi; or between about 3000-4000 psi; or between about 4000-5000 psi. In some embodiments, the compressive strengths described herein are the compressive strengths after 1 day, or 3 days, or 7 days, or 28 days, or 56 days, or longer. In some embodiments, the cement product after setting and hardening has a 28-day compressive strength of at least 250 psi. In some embodiments, the cement product after setting and hardening has a 28-day compressive strength of at least 21 MPa (megapascal) or at least 3046 psi.

In some embodiments, the aggregate, such as e.g., the lightweight aggregate provided herein, is used in making various types of materials used in construction. For example only, the lightweight aggregate provided herein is a form of coarse or fine aggregate that has lower bulk density (more voids or porosity forming honeycomb microstructure) and is utilized to produce lightweight concrete. Common cementitious applications for the lightweight aggregate include, but not limited to, floor slab in high-rise building, concrete masonry unit, or any application where reduced weight of the concrete or the product is desired. The lightweight aggregate can also be utilized to increase the R-Value or insulating properties of the concrete or other material by trapping air inside its structure. In some embodiments, internal curing of the concrete is another use of the lightweight aggregate where the lightweight aggregate may be pre-saturated with water prior to mixing concrete. The water may be then slowly released to the surrounding cement paste providing it with water to chemically react and gain strength. In some embodiments, the lightweight aggregate is used in agricultural applications as a soil additive to improve aeration and water retention or as a soilless growing media, such as used in certain hydroponic setups.

In some embodiments, following ASTM Standards may be applicable to the lightweight aggregate provided herein: ASTM C330M-17a Standard Specification for Lightweight Aggregate for Structural Concrete; ASTM C331M-17 Standard Specification for Lightweight Aggregate for Concrete Masonry Units; ASTM C332-17 Standard Specification for Lightweight Aggregate for Insulating Concrete; ASTM C495M-19 Standard Test Method for Compressive Strength of Lightweight Insulating Concrete; ASTM C513M-19 Obtaining and Testing Specimens of Hardened Lightweight Insulating Concrete for Compressive Strength; ASTM C567M-19 Standard Test Method for Determining Density of Structural Lightweight Concrete; ASTM C641-17 Standard Test Method for Iron Staining Material in Lightweight Concrete Aggregate; ASTM C1761M-17 Standard Specification for Lightweight Aggregate for Internal Curing of Concrete.

In some embodiments, the lightweight aggregate used in forming the concrete contribute to reduced density of the concrete without compromising the compressive strength of the concrete.

In some embodiments, the cement product formed from the composition provided herein, are a formed building material. The “formed building material” used herein includes materials shaped into structures with defined physical shape.

Examples of the formed building material that can be produced by the foregoing methods and systems, include, but not limited to, masonry unit, for example only, brick, block, and tile including, but not limited to, ceiling tile; construction panel, for example only, cement board and/or drywall; conduit; basin; beam; column, slab; acoustic barrier; insulation material; or combination thereof. Construction panel is formed building material employed in a broad sense to refer to any non-load-bearing structural element that is characterized such that its length and width are substantially greater than its thickness. As such the panel may be a plank, a board, shingle, and/or tile.

In some embodiments, the cement board and/or the drywall may be used in making different types of boards such as, but not limited to, paper-faced board, fiberglass-faced or glass mat-faced board (e.g., surface reinforcement with glass fiber mat), fiberglass mesh reinforced board (e.g., surface reinforcement with glass mesh), and/or fiber-reinforced board (e.g., cement reinforcement with cellulose, glass, fiber etc.). These boards may be used in various applications including, but not limited to, siding such as, fiber-cement siding, roofing, soffit, sheathing, cladding, decking, ceiling, shaft liner, wall board, backer, trim, frieze, shingle, and fascia, and/or underlayment. The cement boards are formed building materials which in some embodiments, are used as backer board for ceramics that may be employed behind bathroom tile, kitchen counter, backsplash, etc. and may have lengths ranging from 100 to 200 cm. Cement board may vary in physical and mechanical properties. In some embodiments, the flexural strength may vary, ranging between 1 to 7.5 MPa, including 2 to 6 MPa, such as 5 MPa. The compressive strengths may also vary, ranging from 5 to 50 MPa, including 10 to 30 MPa, such as 15 to 20 MPa. In some embodiments, cement board may be employed in environments having extensive exposure to moisture (e.g., commercial saunas).

Another type of construction panel is backer board. The backer board may be used for the construction of interior, and/or exterior floors, walls, and ceilings. Another type of construction panel is drywall. The drywall includes board that is used for construction of interior, and/or exterior floor, wall, and ceiling. One of the applications of the cement board or drywall is fiber cement siding.

In some embodiments, the formed building material is masonry unit. Masonry unit is formed building material used in the construction of load-bearing and non-load-bearing structures that are generally assembled using mortar, grout, and the like. Exemplary masonry unit formed from the 3D printing include brick, block, and tile.

Another formed building material is a conduit. Conduit is tube or analogous structure configured to convey a gas or liquid, from one location to another. Conduit can include any number of different structures used in the conveyance of a liquid or gas that include, but are not limited to, pipe, culvert, box culvert, drainage channel and portal, inlet structure, intake tower, gate well, outlet structure, and the like.

Another formed building material is basin. The term basin may include any configured container used to hold a liquid, such as water. As such, a basin may include, but is not limited to structure such as well, collection box, sanitary manhole, septic tank, catch basin, grease trap/separator, storm drain collection reservoir, etc.

Another formed building material is a beam, which, in a broad sense, refers to a horizontal load-bearing structure possessing large flexural and compressive strengths. Beam may be rectangular cross-shaped, C-channel, L-section edge beam, I-beam, spandrel beam, H-beam, possess an inverted T-design, etc. Beam may also be horizontal load-bearing unit, which include, but are not limited to joist, lintel, archway, and cantilever.

Another formed building material is a column, which, in a broad sense, refers to a vertical load-bearing structure that carries loads chiefly through axial compression and includes structural elements such as compression members. Other vertical compression members may include, but are not limited to pillar, pier, pedestal, or post.

Another formed building material is a concrete slab. Concrete slab is those building materials used in the construction of prefabricated foundation, floor, and/or wall panel. In some instances, a concrete slab may be employed as a floor unit (e.g., hollow plank unit or double tee design).

Another formed building material is an acoustic barrier, which refers to a structure used as a barrier for the attenuation or absorption of sound. As such, an acoustic barrier may include, but is not limited to, structures such as acoustical panel, reflective barrier, absorptive barrier, reactive barrier, etc.

Another formed building material is an insulation material, which refers to a material used to attenuate or inhibit the conduction of heat. Insulation may also include those materials that reduce or inhibit radiant transmission of heat.

In some embodiments, the other formed building material such as pre-cast concrete product includes, but not limited to, bunker silo; cattle feed bunk; cattle grid; agricultural fencing; H-bunk; J-bunk; livestock slat; livestock watering trough; architectural panel wall; cladding (brick); building trim; foundation; floor, including slab on grade; wall; double wall precast sandwich panel; aqueduct; mechanically stabilized earth panel; box culvert; 3-sided culvert; bridge system; RR crossing; RR tie; sound walls/barrier; Jersey barrier; tunnel segment; reinforced concrete box; utility protection structure; hand hole; hollow core product; light pole base; meter box; panel vault; pull box; telecom structure; transformer pad; transformer vault; trench; utility vault; utility pole; controlled environment vault; underground vault; mausoleum; grave stone; coffin; Haz mat storage container; detention vault; catch basin; manhole; aeration system; distribution box; dosing tank; dry well; grease interceptor; leaching pit; sand-oil/oil-water interceptor; septic tank; water/sewage storage tank; wet wells; fire cisterns; floating dock; underwater infrastructure; decking; railing; sea wall; roofing tile; paver; community retaining wall; res. retaining wall; modular block system; and segmental retaining wall.

In some embodiments, the methods and systems described herein include making cementitious artificial marine structures from the compositions provided herein including, but not limited to, artificial coral and reef. In some embodiments, the artificial structure can be used in the aquarium or sea. In some embodiments, the aragonitic cement provides neutral or close to neutral pH which may be conducive for maintenance and growth of marine life. The aragonitic reef may provide suitable habitat for marine species.

In some embodiments, the compositions, methods, and systems described herein include making non-cementitious products including paper, polymer product, lubricant, adhesive, rubber product, chalk, asphalt product, paint, abrasive for paint removal, personal care product, cosmetic, cleaning product, dental product, personal hygiene product, ingestible product, agricultural product, soil amendment product, pesticide, environmental remediation product, and combination thereof.

Throughout the description, where compositions are described as having, including, or comprising specific components, or where processes and methods are described as having, including, or comprising specific steps, it is contemplated that, additionally, there are compositions of the present invention that consist essentially of, or consist of, the recited components, and that there are processes and methods according to the present invention that consist essentially of, or consist of, the recited processing steps.

In the application, where an element or component is said to be included in and/or selected from a list of recited elements or components, it should be understood that the element or component can be any one of the recited elements or components, or the element or component can be selected from a group consisting of two or more of the recited elements or components.

Further, it should be understood that elements and/or features of a composition or a method described herein can be combined in a variety of ways without departing from the spirit and scope of the present invention, whether explicit or implicit herein. For example, where reference is made to a particular composition, that composition can be used in various embodiments of compositions of the present invention and/or in methods of the present invention, unless otherwise understood from the context. In other words, within this application, embodiments have been described and depicted in a way that enables a clear and concise application to be written and drawn, but it is intended and will be appreciated that embodiments may be variously combined or separated without parting from the present teachings and invention(s). For example, it will be appreciated that all features described and depicted herein can be applicable to all aspects of the invention(s) described and depicted herein.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

Certain ranges are presented herein with numerical values being preceded by the term “about.” The term “about” is used herein to provide literal support for the exact number that it precedes, as well as a number that is near to or approximately the number that the term precedes. As used herein, the term “about” refers to a ±10% variation from the nominal value unless otherwise indicated or inferred.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the invention, representative illustrative methods and materials are described herein.

All publications, patents, and patent applications cited in this specification are incorporated herein by reference to the same extent as if each individual publication, patent, or patent application were specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided may be different from the actual publication dates, which may need to be independently confirmed.

It should be understood that the expression “at least one of” includes individually each of the recited objects after the expression and the various combinations of two or more of the recited objects unless otherwise understood from the context and use.

It is noted that, as used herein and in the appended claims, the singular forms “a”, “an”, and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method can be carried out in the order of events recited or in any other order, which is logically possible. It should be understood that the order of steps or order for performing certain actions is immaterial so long as the present invention remain operable. Moreover, two or more steps or actions may be conducted simultaneously.

The following examples are put forth to provide those of ordinary skill in the art with a complete disclosure and description of how to make and use the invention and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for.

### EXAMPLES

### Example 1

### Blend of the Vaterite Particles with the GCC Particles Vs. Vaterite Particles Alone

In one set, a composition containing 100% vaterite particles was taken. In another set, the vaterite particles were combined with the ground calcium carbonate in a mass ratio of 9:1 (10% GCC) to produce the calcium carbonate blend composition. The median particle size of the vaterite particles and the GCC were 19 μm and 2 μm, respectively. The blend was then combined with sand and water in 1:2.75:0.33 mass ratio to form a cement paste and mixed in a stand mixer till homogeneous. Two-inch mortar cubes were then cast, covered with plastic film, and cured at 23° C. for 1 day and 3 days. After curing, the cubes were dried to constant mass at 110° C., allowed to cool, and then tested in compression according to ASTM C109. After 1 day of curing, the average compressive strength of the cement mortar made from the calcium carbonate blend composition was 3,260±10 psi.

After compression testing, the calcium carbonate cement pastes were separated from the mortar cubes by gently crushing followed by sieving. Analysis by X-ray diffraction indicated the blended calcium carbonate cement paste had transformed from 90% vaterite and 10% calcite initially to 2% vaterite and 98% calcite after 1-day of curing at room temperature. In comparison, the 100% vaterite cement had transformed to 90% calcite by 1 day. Both cements had transformed to 100% calcite by 3 days (shown in Table I below). Blending of the vaterite particles in 10% GCC particles, resulted in a faster transformation of the vaterite to the calcite and helped improve and maintain the compressive strength.

TABLE I

| | 1-Day of Curing | | | 3-Days of Curing | | |
|---|---|---|---|---|---|---|
| | Strength | Vaterite | Calcite | Strength | Vaterite | Calcite |
| | (psi) | (%) | (%) | (psi) | (%) | (%) |
| 100% | 2490 | 10 | 90 | 1640 | 0 | 100 |
| Vaterite | | | | | | |
| particles | | | | | | |
| Blend of | 3260 | 2 | 98 | 3150 | 0 | 100 |
| 90% | | | | | | |
| Vaterite | | | | | | |
| particles | | | | | | |
| & 10% | | | | | | |
| GCC | | | | | | |

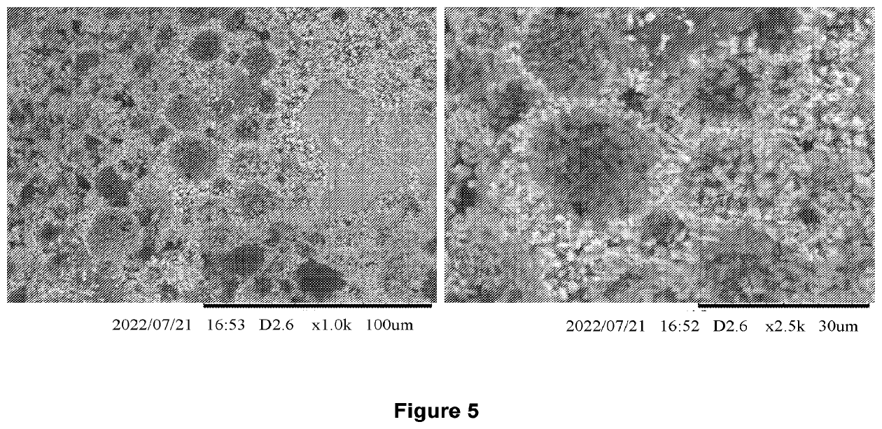

FIG. 5 shows scanning electron microscopy (SEM) images of the microstructure of the cement mortar made from the calcium carbonate blend composition at 1,000× magnification and at 2,500× magnification after 1 day of curing. The SEM image with 2,500× magnification clearly shows the calcite matrix surrounding one or more voids, forming a honeycomb structure.

Although the foregoing invention has been described in some detail by way of illustration and example for purposes of clarity of understanding, it should be readily apparent to those of ordinary skill in the art in light of the teachings of this invention that certain changes and modifications may be made thereto without departing from the spirit or scope of the appended claims. Accordingly, the preceding merely illustrates the principles of the invention. It will be appreciated that those skilled in the art will be able to devise various arrangements, which, although not explicitly described or shown herein, embody the principles of the invention, and are included within its spirit and scope. Furthermore, all examples and conditional language recited herein are principally intended to aid the reader in understanding the principles of the invention and the concepts contributed by the inventors to furthering the art and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein. It is intended that the following claims define the scope of the invention and that methods and structures within the scope of these claims and their equivalents be covered thereby.

### EXEMPLARY ASPECTS

The following exemplary aspects are provided, the numbering of which is not to be construed as designating levels of importance:

Aspect 1 provides a calcium carbonate blend composition, comprising: a blend comprising vaterite particles having an average particle size of between about 0.1-50 μm and ground calcium carbonate (GCC) particles having an average particle size of between about 1-150 μm.

Aspect 2 provides the calcium carbonate blend composition of Aspect 1, wherein the blend comprises vaterite particles having an average particle size of between about 10-25 μm and the GCC particles having an average particle size of between about 1-10 μm.

Aspect 3 provides the calcium carbonate blend composition of Aspect 1 or 2, wherein the blend comprises vaterite particles between about 3-97% by weight and the GCC particles between about 3-97% by weight.

Aspect 4 provides the calcium carbonate blend composition of any one of the preceding Aspects, wherein the blend comprises vaterite particles between about 3-50% by weight and the GCC particles between about 3-50% by weight.

Aspect 5 provides the calcium carbonate blend composition of any one of the preceding Aspects, wherein the blend improves packing density of cement paste by between about 1-35%; reduces viscosity of cement paste by about 10% or more; and/or increases strength of cement paste, mortar, concrete, or composite by about 5% or more.

Aspect 6 provides the calcium carbonate blend composition of any one of the preceding Aspects, wherein the vaterite is stable vaterite, reactive vaterite, or combination thereof.

Aspect 7 provides the calcium carbonate blend composition of any one of the preceding Aspects, wherein the blend comprises vaterite particles having a specific surface area of between about 200-40,000 m²/kg and the GCC particles having a specific surface area of between about 100-10,000 m²/kg.

Aspect 8 provides the calcium carbonate blend composition of any one of the preceding Aspects, wherein the GCC particles are synthetic, natural, or combination thereof.

Aspect 9 provides the calcium carbonate blend composition of any one of the preceding Aspects, wherein the vaterite particles further comprise magnesium oxide.

Aspect 10 provides the calcium carbonate blend composition of any one of the preceding Aspects, wherein the composition further comprises other component comprising aluminosilicate material.

Aspect 11 provides the calcium carbonate blend composition of Aspect 10, wherein the aluminosilicate material comprises heat-treated clay, natural or artificial pozzolan, shale, granulated blast furnace slag, or combination thereof.

Aspect 12 provides the calcium carbonate blend composition of Aspect 11, wherein the heat-treated clay comprises calcined clay, aluminosilicate glass, calcium aluminosilicate glass, or combination thereof.

Aspect 13 provides the calcium carbonate blend composition of Aspect 11, wherein the pozzolan is selected from the group consisting of fly ash, volcanic ash, and mixture thereof.

Aspect 14 provides the calcium carbonate blend composition of any one of the preceding Aspects, wherein the composition further comprises one or more other component selected from the group consisting of slag from metal production, Portland cement clinker, calcium aluminate cement clinker, calcium sulfoaluminate cement clinker, aluminosilicate material, supplementary cementitious material (SCM), and combination thereof.

Aspect 15 provides the calcium carbonate blend composition of any one of the preceding Aspects, wherein the composition further comprises other component comprising carbonate material comprising magnesium carbonate, calcium magnesium carbonate, or combination thereof.

Aspect 16 provides the calcium carbonate blend composition of any one of the preceding Aspects, wherein the composition further comprises other component comprising alkali metal accelerator or an alkaline earth metal accelerator.

Aspect 17 provides the calcium carbonate blend composition of Aspect 16, wherein the alkali metal accelerator or the alkaline earth metal accelerator is selected from sodium sulfate, sodium carbonate, sodium nitrate, sodium nitrite, sodium hydroxide, potassium sulfate, potassium carbonate, potassium nitrate, potassium nitrite, potassium hydroxide, lithium sulfate, lithium carbonate, lithium nitrate, lithium nitrite, lithium hydroxide, calcium sulfate, calcium nitrate, calcium nitrite, and combination thereof.

Aspect 18 provides the calcium carbonate blend composition of any one of the preceding Aspects, comprising by weight between about 5-50% of the blend, between about 5-50% calcined clay, and between about 15-90% Portland cement clinker.

Aspect 19 provides the calcium carbonate blend composition of any one of the preceding Aspects, wherein the composition after setting and hardening has a 28-day compressive strength of at least 21 MPa.

Aspect 20 provides the calcium carbonate blend composition of any one of the preceding Aspects, wherein the composition further comprises other component comprising admixture selected from the group consisting of set accelerator, set retarder, air-entraining agent, foaming agent, defoamer, alkali-reactivity reducer, bonding admixture, dispersant, coloring admixture, corrosion inhibitor, damp-proofing admixture, gas former, permeability reducer, pumping aid, shrinkage compensation admixture, fungicidal admixture, germicidal admixture, insecticidal admixture, rheology modifying agent, finely divided mineral admixture, pozzolan, aggregate, wetting agent, strength enhancing agent, water repellent, reinforcing material, and combination thereof.

Aspect 21 provides a concrete mix comprising the calcium carbonate blend composition of any one of the preceding Aspects and aggregate.

Aspect 22 provides a calcium carbonate blend paste or calcium carbonate blend slurry composition, comprising: a blend comprising vaterite particles having an average particle size of between about 0.1-50 μm and GCC particles having an average particle size of between about 1-150 μm, and water, and optionally interlocking acicular shaped aragonite, calcite, carboaluminate, or combination thereof.

Aspect 23 provides a cement product formed from the calcium carbonate blend composition of any one of the preceding Aspects, comprising: an interlocking acicular shaped aragonite microstructure and the GCC particles.

Aspect 24 provides the cement product of Aspect 23, wherein the interlocking acicular shaped aragonite surrounds one or more voids optionally forming a honeycomb structure.

Aspect 25 provides a cement product formed from the calcium carbonate blend composition of any one of the Aspects 1-22, comprising: a calcite matrix and the GCC particles surrounding one or more voids optionally forming a honeycomb structure.

Aspect 26 provides the cement product of any one of the Aspects 23-25, wherein the cement product is building material, formed building material, and/or artificial marine structure.

Aspect 27 provides a method of producing a calcium carbonate blend composition, comprising:
(a) calcining limestone to form a mixture comprising lime and a gaseous stream comprising carbon dioxide; (b) dissolving the mixture comprising lime in a N-containing salt solution to produce an aqueous solution comprising calcium salt; (c) treating the aqueous solution comprising calcium salt with the gaseous stream comprising carbon dioxide to form a composition comprising vaterite particles having an average particle size of between about 0.1-50 μm; (d) blending the composition comprising vaterite particles with GCC particles to form a blend comprising the vaterite particles having an average particle size of between about 0.1-50 μm and the GCC particles having an average particle size of between about 1-150 μm; and (e) forming a calcium carbonate blend composition comprising the blend.

Aspect 28 provides a method of producing a calcium carbonate blend composition, comprising:
(a) dissolving limestone in a N-containing salt solution to produce an aqueous solution comprising calcium salt and a gaseous stream comprising carbon dioxide; (b) treating the aqueous solution comprising calcium salt with the gaseous stream comprising carbon dioxide to form a composition comprising vaterite particles having an average particle size of between about 0.1-50 μm; (c) blending the composition comprising the vaterite particles with GCC particles to form a blend comprising the vaterite particles having an average particle size of between about 0.1-50 μm and the GCC particles having an average particle size of between about 1-150 μm; and (d) forming a calcium carbonate blend composition comprising the blend.

Aspect 29 provides the method of any one of the Aspects 27-28, wherein the vaterite is reactive vaterite, stable vaterite, or combination thereof.

Aspect 30 provides the method of any one of the Aspects 27-29, further comprising forming cementitious product and/or non-cementitious product from the calcium carbonate blend composition.

Aspect 31 provides the method of Aspect 29 or 30, further comprising adding water to the calcium carbonate blend composition and transforming the reactive vaterite particles to aragonite and/or calcite upon dissolution and re-precipitation in water.

Aspect 32 provides the method of Aspect 31, further comprising setting and hardening of the aragonite and/or the calcite and forming cementitious product.

Aspect 33 provides the method of any one of the Aspects 26-32, wherein the blend improves packing density of cement paste by between about 1-35%; reduces viscosity of cement paste by 10% or more; and/or increases strength of cement paste, mortar, concrete, or composite by 5% or more.

Aspect 34 provides a system to form a calcium carbonate blend composition, comprising:
(i) a calcining reactor configured to calcine limestone to form a mixture comprising lime and a gaseous stream comprising carbon dioxide;
(ii) a dissolution reactor operably connected to the calcination reactor configured for dissolving the mixture comprising lime in an aqueous N-containing salt solution to produce an aqueous solution comprising calcium salt;
(iii) a treatment reactor operably connected to the dissolution reactor configured for treating the aqueous solution comprising calcium salt with the gaseous stream comprising carbon dioxide to form a composition comprising vaterite particles having an average particle size of between about 0.1-50 μm; and
(iv) a blending station operably connected to the treatment reactor and configured for forming a blend comprising the vaterite particles having an average particle size of between about 0.1-50 μm and GCC particles having an average particle size of between about 1-150 μm and forming a calcium carbonate blend composition comprising the blend.

Aspect 35 provides a system to form a calcium carbonate blend composition, comprising:
(i) a dissolution reactor configured for dissolving limestone with N-containing salt solution to produce an aqueous solution comprising calcium salt and a gaseous stream comprising carbon dioxide;
(ii) a treatment reactor operably connected to the dissolution reactor configured for treating the aqueous solution comprising calcium salt with the gaseous stream comprising carbon dioxide to form a composition comprising vaterite particles having an average particle size of between about 0.1-50 μm; and
(iii) a blending station operably connected to the treatment reactor and configured for forming a blend comprising the vaterite particles having an average particle size of between about 0.1-50 μm and GCC particles having an average particle size of between about 1-150 μm and forming a calcium carbonate blend composition comprising the blend.

1. A calcium carbonate blend composition, comprising: a blend comprising vaterite particles having an average particle size of between about 0.1-50 μm and ground calcium carbonate (GCC) particles having an average particle size of between about 1-150 μm.

2. The calcium carbonate blend composition of claim 1, wherein the blend comprises vaterite particles having an average particle size of between about 10-25 μm and the GCC particles having an average particle size of between about 1-10 μm.

3. The calcium carbonate blend composition of claim 1, wherein the blend comprises vaterite particles between about 3-97% by weight and the GCC particles between about 3-97% by weight.

4. (canceled)

5. The calcium carbonate blend composition of claim 1, wherein the blend improves packing density of cement paste by between about 1-35%; reduces viscosity of cement paste by about 10% or more; and/or increases strength of cement paste, mortar, concrete, or composite by about 5% or more.

6. (canceled)

7. The calcium carbonate blend composition of claim 1, wherein the blend comprises vaterite particles having a specific surface area of between about 200-40,000 m²/kg and the GCC particles having a specific surface area of between about 100-10,000 m²/kg.

8. (canceled)

9. The calcium carbonate blend composition of claim 1, wherein the vaterite particles further comprise magnesium oxide.

10. The calcium carbonate blend composition of claim 1, wherein the composition further comprises other component comprising aluminosilicate material.

11. The calcium carbonate blend composition of claim 10, wherein the aluminosilicate material comprises heat-treated clay, natural or artificial pozzolan, shale, granulated blast furnace slag, or combination thereof.

12. (canceled)

13. (canceled)

14. The calcium carbonate blend composition of claim 1, wherein the composition further comprises one or more other component selected from the group consisting of slag from metal production, Portland cement clinker, calcium aluminate cement clinker, calcium sulfoaluminate cement clinker, aluminosilicate material, supplementary cementitious material (SCM), and combination thereof.

15. The calcium carbonate blend composition of claim 1, wherein the composition further comprises other component comprising carbonate material comprising magnesium carbonate, calcium magnesium carbonate, or combination thereof.

16. The calcium carbonate blend composition of claim 1, wherein the composition further comprises other component comprising alkali metal accelerator or an alkaline earth metal accelerator.

17. (canceled)

18. The calcium carbonate blend composition of claim 1, comprising by weight between about 5-50% of the blend, between about 5-50% calcined clay, and between about 15-90% Portland cement clinker.

19. The calcium carbonate blend composition of claim 1, wherein the composition after setting and hardening has a 28-day compressive strength of at least 21 MPa.

20. The calcium carbonate blend composition of claim 1, wherein the composition further comprises other component comprising admixture selected from the group consisting of set accelerator, set retarder, air-entraining agent, foaming agent, defoamer, alkali-reactivity reducer, bonding admixture, dispersant, coloring admixture, corrosion inhibitor, damp-proofing admixture, gas former, permeability reducer, pumping aid, shrinkage compensation admixture, fungicidal admixture, germicidal admixture, insecticidal admixture, rheology modifying agent, finely divided mineral admixture, pozzolan, aggregate, wetting agent, strength enhancing agent, water repellent, reinforcing material, and combination thereof.

21. A concrete mix comprising the calcium carbonate blend composition of claim 1 and aggregate.

22. (canceled)

23. A cement product formed from the calcium carbonate blend composition of claim 1, comprising: an interlocking acicular shaped aragonite microstructure and the GCC particles.

24. (canceled)

25. (canceled)

26. (canceled)

27. A method of producing a calcium carbonate blend composition, comprising:
(a) calcining limestone to form a mixture comprising lime and a gaseous stream comprising carbon dioxide; (b) dissolving the mixture comprising lime in a N-containing salt solution to produce an aqueous solution comprising calcium salt; (c) treating the aqueous solution comprising calcium salt with the gaseous stream comprising carbon dioxide to form a composition comprising vaterite particles having an average particle size of between about 0.1-50 μm; (d) blending the composition comprising vaterite particles with GCC particles to form a blend comprising the vaterite particles having an average particle size of between about 0.1-50 μm and the GCC particles having an average particle size of between about 1-150 μm; and (e) forming a calcium carbonate blend composition comprising the blend.

28. (canceled)

29. (canceled)

30. The method of claim 27, further comprising forming cementitious product and/or non-cementitious product from the calcium carbonate blend composition.

31. (canceled)

32. (canceled)

33. The method of claim 27, wherein the blend improves packing density of cement paste by between about 1-35%; reduces viscosity of cement paste by 10% or more; and/or increases strength of cement paste, mortar, concrete, or composite by 5% or more.

34. A system to form a calcium carbonate blend composition, comprising:
(i) a calcining reactor configured to calcine limestone to form a mixture comprising lime and a gaseous stream comprising carbon dioxide;
(ii) a dissolution reactor operably connected to the calcination reactor configured for dissolving the mixture comprising lime in an aqueous N-containing salt solution to produce an aqueous solution comprising calcium salt;
(iii) a treatment reactor operably connected to the dissolution reactor configured for treating the aqueous solution comprising calcium salt with the gaseous stream comprising carbon dioxide to form a composition comprising vaterite particles having an average particle size of between about 0.1-50 μm; and
(iv) a blending station operably connected to the treatment reactor and configured for forming a blend comprising the vaterite particles having an average particle size of between about 0.1-50 μm and GCC particles having an average particle size of between about 1-150 μm and forming a calcium carbonate blend composition comprising the blend.

35. (canceled)
